(19) United States
(12) Patent Application Publication
(10) Pub. No.: US 2012/0209756 A1
(43) Pub. Date: Aug. 16, 2012

(54) METHOD AND SYSTEM FOR PROVIDING A DECISION SUPPORT FRAMEWORK RELATING TO FINANCIAL TRADES

(76) Inventors: Hani El-Sakkout, Forest Hills, NY (US); Vassilios Liatsos, Astoria, NY (US)

(21) Appl. No.: 13/371,040

(22) Filed: Feb. 10, 2012

Related U.S. Application Data
(60) Provisional application No. 61/441,521, filed on Feb. 10, 2011.

(51) Int. Cl. G06Q 40/04

(52) U.S. Cl. 705/37

(57) ABSTRACT

The system and method described herein includes techniques for making trading decisions based on one or more predictions, outcomes, market data and optimization algorithms. More specifically, the system and method described herein allow users to provide a variety of inputs for consideration by a variety of optimization techniques. The system and methods are flexible with respect to the type of input received and the types of output desired.

### CROSS REFERENCE TO RELATED APPLICATION

This application claims priority to provisional application 61/441,521 filed, Feb. 10, 2011 titled “Method and System for Providing a Decision Support Framework Relating to Derivative Trades,” and is hereby incorporated by reference in its entirety.

### FIELD OF THE INVENTION

The present invention relates generally to a financial trade decision support framework, and, more particularly, to a method and system for enabling a trader to optimize a selection of security and derivative contracts.

### SUMMARY

Embodiments of the present invention relate to a method and system for providing a decision support framework to derivatives traders—and other interested derivative trading user communities such as research analysts, fund managers, market makers, external computer trading platforms and systems, or other interested human and automated system users (herein referred to as “Users”).

The system and method according to embodiments of the present invention, herein referred to as the “Tradelegs Optimization Method and System”, comprises a computer platform (herein, the “Tradelegs Platform” or the “tradelegs platform”) configured to execute instructions configured to enable one or more Users to optimize a selection of security and derivative contracts, by enabling them to make Predictions describing the impact of future potential outcomes on the performance of securities, at a given Target Date. The predictions can be absolute (i.e., the prediction of the impact a set of outcomes has on a securities' actual price), or relative (i.e., the prediction of the outcomes' impact on their prices relative to the price of another security or basket of securities; a benchmark ETF; or another form of index fund). For the purposes of this document, certain defined terms are capitalized.

According to embodiments of the present invention, the User inputs the maximum capital risked in the trade, and the maximum invested capital available for executing the trade. These parameters together are utilized by the Tradelegs Optimization Method and System to identify the funds available for trading.

Optionally, for additional flexibility, multiple Predictions may be grouped within a Scenario. As used herein, a Scenario is defined to be a set of (possibly unrelated) Predictions that compete for the same pool of trading capital. Scenarios enable different degrees of confidence to be communicated to the Tradelegs Optimization Method and System, allowing the Tradelegs Optimization Method and System to allocate the available trading funds across the predictions, while observing the User's varying degrees of prediction confidence, as well as the most attractive security and option contract market prices at the time of trade entry.

According to embodiments of the present invention, in addition to the aforementioned parameters, many additional constraints are observed by the Tradelegs Optimization Method and System for the purposes of modeling various aspects of the trade, such as, for example, the price effects of limited liquidity; the User's requirement for portfolio diversification; minimum P/L probability; or minimum acceptable ROI, etc.

According to embodiments of the present invention, different optimization functions may be selected by the User to focus the optimizer on maximizing the expected profit; or maximizing the expected ROI; or on optimizing other trade parameters that are of interest to the Users.

According to embodiments of the present invention, the Tradelegs Optimization Method and System may be comprised of computer executable instructions executed and processed by one or more computers to perform the various functions, actions, and steps described in detail herein, according to embodiments of the present invention. As used herein, the term “computer” is intended to include any data processing device, such as a desktop computer, a laptop computer, a mainframe computer, a personal digital assistant, a server, or any other device able to process, manage or transmit data, whether implemented with electrical, magnetic, optical, biological components or otherwise. One having ordinary skill in the art will appreciate that any number of computers and/or software modules may be utilized in implementing the Tradelegs Optimization Method and System according to the present invention.

According to embodiments of the present invention, the Tradelegs Optimization Method and System may be implemented using a computer including memory resources coupled to a processor via a bus. The memory resource can include, but is not limited to, random access memory (RAM), read only memory (ROM), and/or other storage media capable of storing computer executable instructions, e.g., program instructions, that can be executed by the processor to perform various embodiments of the present disclosure. The memory resource instructions may store computer executable instructions either permanently or temporarily.

According to embodiments of the present invention, the Tradelegs Optimization Method and System comprises a computer-implemented method configured to implement, perform, and execute the various features and functions described in detail below.

### BRIEF DESCRIPTION OF THE DRAWINGS

FIG. 1 illustrates one embodiment of a network environment including a Tradelegs Platform.

FIG. 2 illustrates one embodiment of a Tradelegs Platform system.

FIG. 3 illustrates a flow diagram of a method of presenting an optimized trade position to a user, according to an embodiment of the present invention.

FIG. 4 illustrates a flow diagram of a method of presenting a consolidated performance prediction curve to a user, according to an embodiment of the present invention;

FIG. 5 illustrates an exemplary performance prediction curve graph, according to an embodiment of the present invention.

FIG. 6 illustrates an exemplary performance prediction curve graph, according to an embodiment of the present invention.

FIG. 7 illustrates an exemplary performance prediction curve graph, according to an embodiment of the present invention.

FIG. 8 illustrates an exemplary screenshot of a user interface, according to an embodiment of the present invention.

FIG. 9 illustrates an exemplary screenshot of a user interface, according to an embodiment of the present invention.

FIG. 10 illustrates exemplary model payoff curves, according to an embodiment of the present invention.

FIG. 11 illustrates exemplary model payoff curves, according to an embodiment of the present invention.

FIG. 12 illustrates an exemplary model payoff curve, according to an embodiment of the present invention.

FIG. 13 illustrates an exemplary model payoff curve, according to an embodiment of the present invention.

FIG. 14 illustrates an exemplary consolidated performance prediction curve, according to an embodiment of the present invention.

FIG. 15 illustrates an exemplary expected payoff curve, according to an embodiment of the present invention.

FIG. 16 illustrates an exemplary screenshot of a user interface, according to an embodiment of the present invention.

FIG. 17 illustrates an exemplary screenshot of a user interface, according to an embodiment of the present invention.

FIG. 18 illustrates one embodiment of a graph.

FIG. 19 illustrates a screenshot of a graphical user interface.

FIG. 20 illustrates one embodiment of a graph.

FIG. 21 illustrates one embodiment of a graph; and

FIG. 22 illustrates one embodiment of a graph.

### DETAILED DESCRIPTION

### Computer Architecture and Platforms

As used herein, the term “software” or “computer executable instructions” refers to instructions that may be performed by a processor and/or other suitable components. The term “storage media” can includes various storage media that can be used to store computer executable instructions. Storage media can include non-volatile media and/or volatile media, among other types of media and can be in the form of magnetic media, optical media, and/or physical media, among others. Some examples include hard disks, floppy disks, CD ROMs, DVDs, and Flash memory. Embodiments of the present disclosure are not limited to a particular type of storage media.

According to embodiments of the present invention, the one or more computers may be coupled to a display. The display can be a liquid crystal display (LCD) monitor or a cathode ray tube (CRT), or any other display type capable of displaying information to a user.

According to embodiments of the present invention, the one or more computers may be coupled to one or more input devices, including, but not limited to a keyboard, voice activated system, touch screen system, and/or mouse, among various other input devices.

According to embodiments of the present invention, the one or more computers include a communication interface configured to provide data communication coupling between the one or more computers and any communicatively connected components, such as a network, other computing devices, e.g., client and/or server devices, storage media, and the like. As used herein, the term communicatively connected is intended to include any type of connection, whether wired or wireless, in which data may be communicated. Furthermore, the term “communicatively connected” is intended to include a connection between devices and/or programs within a single computer or between devices and/or programs on separate computers. As a non-limiting example, the communication interface can be an integrated services digital network (ISDN) card or a modem used to provide a data communication connection to a corresponding type of telephone line. The communication interface can also be a LAN card used to provide a data communication connection to a compatible LAN. The interface can also be a wireless link used to send and receive various types of information. The scope of the various embodiments of the present disclosure includes other applications in which the above structures and methods are used.

Although specific embodiments have been illustrated and described herein, those of ordinary skill in the art will appreciate that an arrangement configured to achieve the same results can be substituted for the specific embodiments shown. This disclosure is intended to cover adaptations or variations of various embodiments apparent to those of ordinary skill in the art. It is to be understood that the above description has been made in an illustrative fashion, and not a restrictive one. Combination of the above embodiments, and other embodiments not specifically described herein will be apparent to those of skill in the art upon reviewing the above description.

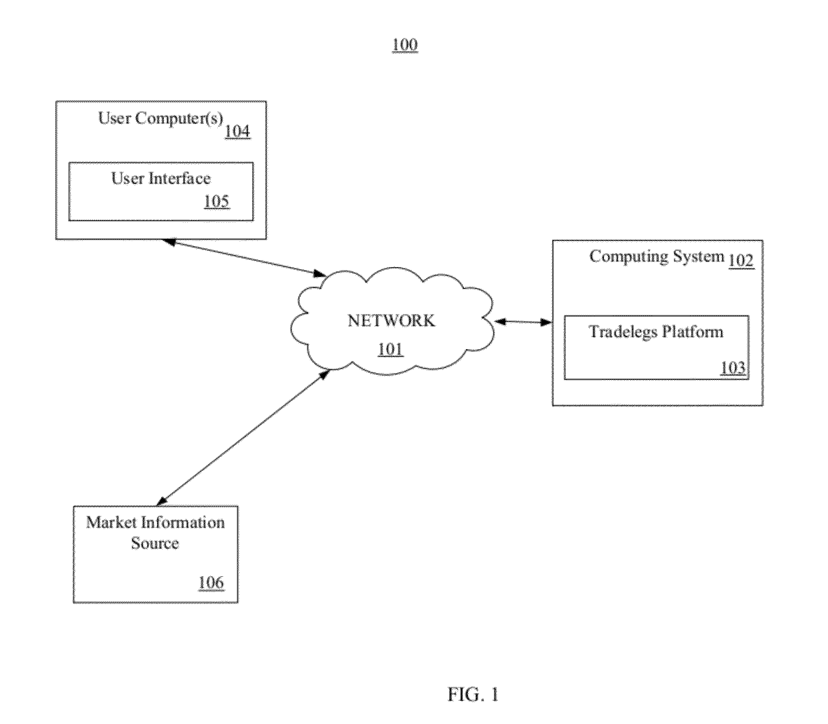

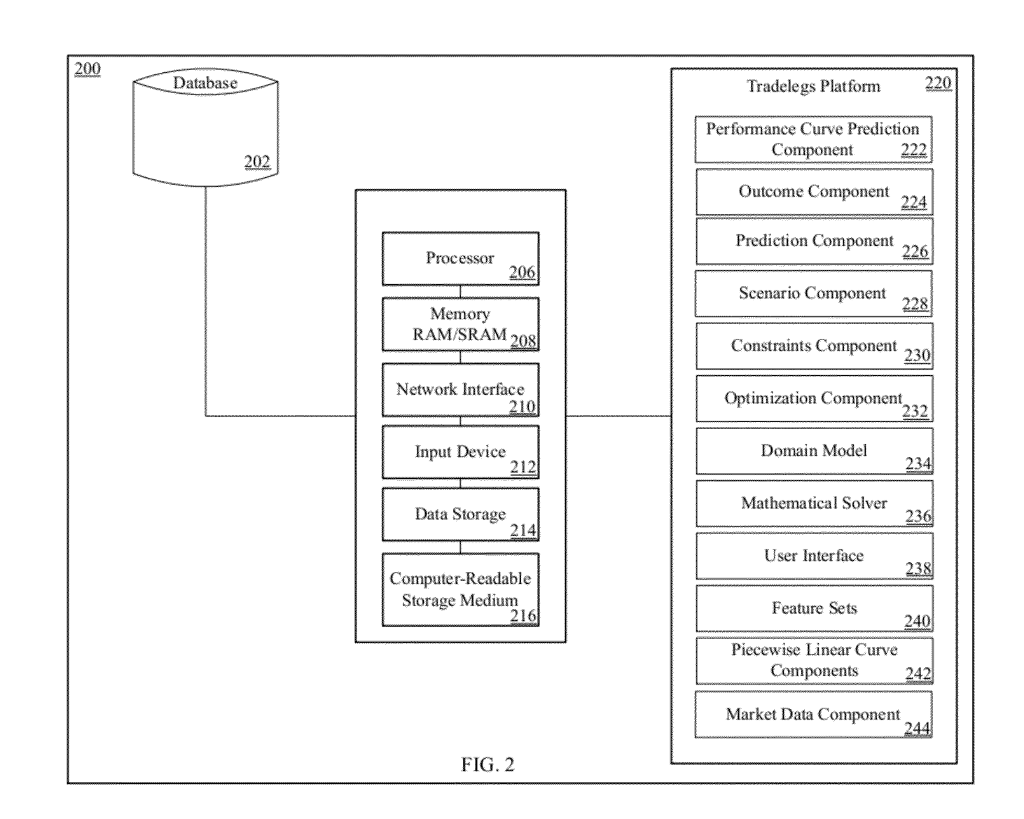

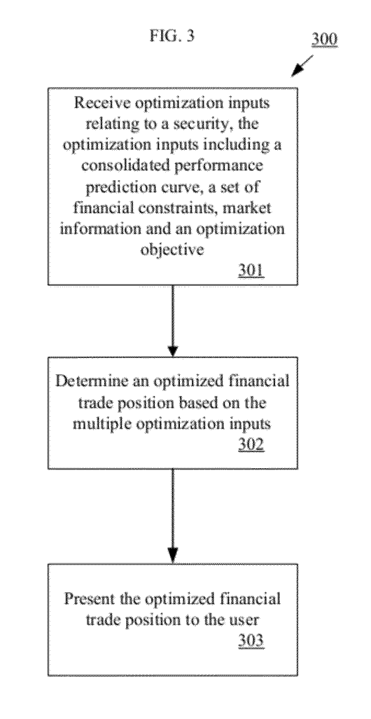

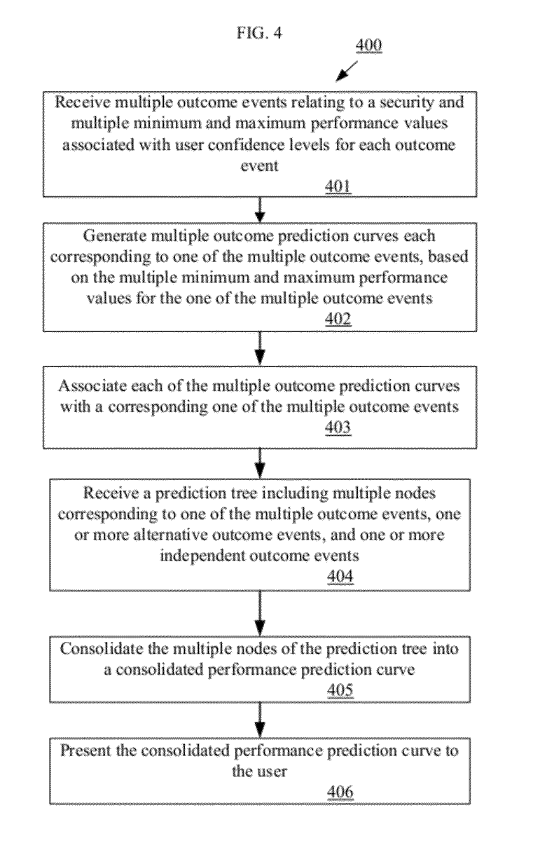

FIG. 1 illustrates one embodiment of an exemplary network computing environment 100 within which a Tradelegs Platform 103 may operate. The network computing environment 100 includes a network 101, a computing system 102 configured to include the Tradelegs Platform 103, one or more user computers 104 including a user interface 105, and a market information source 106. The network 101 may include a plurality of networks, including the Internet, an extranet, an intranet, a virtual private network VPN network a local area network LAN, a metropolitan area network MAN, a wide area network WAN and/or the like. These networks may be in operable communication through a combination of wired and wireless communication standards, hardware and configurations. The computer system 102 includes a computing device or multiple computing devices configured to host and execute the Tradelegs Platform 103. For example, the computer system 102 may include a virtualized server, a personal computer, a mobile device, a virtual appliance computer and/or the like. The Tradelegs Platform 103 may include software and hardware configured to provide the functionality described herein in detail, including, for example, the methods illustrated in FIGS. 3 and 4. In an embodiment of the present invention, the Tradelegs Platform 103 includes the components illustrated in FIG. 2.

According to an embodiment of the present invention, the Tradelegs Platform 103 may include a number of different layers (e.g., data processing and optimization components/modules) that are distributed over multiple computing systems 102 (e.g., servers), which may be physically located in multiple locations that are remote from one another.

Although FIG. 1 shows the user computer(s) 104 connected to the computing system 102 (and Tradelegs Platform 103) via the network 101, according to another embodiment, the user computer(s) 104 may include the Tradelegs Platform 103 as a locally executable application/program. In this embodiment, the user interface 105 and the Tradelegs Platform 103 are on a single computing device (e.g., the user computer 104) without a network connection therebetween.

According to an embodiment of the present invention, the Tradelegs Platform 103 may be implemented in a distributed computing architecture including a number of geographically dispersed cloud computing locales. For example, the Tradelegs Platform 103 may include one or more components or modules (such as, for example, the components illustrated in FIG. 2) duplicated and on standby in different availability zones, or distributed over any number of different computing systems (e.g., servers) communicatively connected to one another via any suitable network connection.

The user computer(s) 104 may include any suitable computer device configured to allow a user to access the Tradelegs Platform 103 using, for example, the user interface 105. The user computer(s) 104 may include a virtualized server, a personal computer, a mobile device, a virtual appliance computer and/or the like. In one embodiment, the network computer 104 may be a client device. In one embodiment, the Tradelegs Platform 103 may include additional components and/or functionally. A market information source 106 may be any suitable computing device configured to provide market information to the Tradelegs Platform 103. In one embodiment, the market information source 106 may be an exchange, a financial institution, a news media source, an aggregation of digital media sources (e.g., a Really Simple Syndication, RSS feed), a Twitter feed and/or the like. In an embodiment, the user computer(s) 104 are configured to provide information to the Tradelegs Platform 103, such as, for example, security data, financial data, company data, prediction data, outcome data, scenario data and/or the like.

FIG. 2 illustrates one embodiment of a trade optimization system 200. In an embodiment, the trade optimization system 200 may include a database 202, a processor 206, a memory 208, a network interface 210, an input device 212, a data storage 214, a computer readable storage medium 216, and a Tradelegs Platform 220 (e.g., the Tradelegs Platform 103 shown in FIG. 1).

As mentioned above, the Tradelegs Platform 220 may be implemented using a computer including memory resources coupled to a processor 206 via a bus. The memory resource(s) 208, 214, and 216 can include, but is not limited to, random access memory (RAM), read only memory (ROM), and/or other storage media capable of storing computer executable instructions, e.g., program instructions, that can be executed by the processor 206 to perform various embodiments of the present disclosure. The memory resource instructions may store computer executable instructions either permanently or temporarily. A network interface 210 card may include a network controller operable to communicate over various communication protocols, including TCP/IP, token ring, Ethernet, Wi-Fi, bluetooth, IPSec, 3G, 4G, GSM, CDMA and/or the like. The database 202 may include any suitable database. For example, the database 202 may include an implementation or a combination of mySQL, SQLSERVER® and ORACLE®. These databases may further be implemented as a C-store database.

In an embodiment, the Tradelegs Platform 220 includes a performance prediction curve component 222, an outcome component 224, a prediction component 226, a scenario component 228, a constraints component 230, an optimization component 232, a domain model 234, a mathematical solver 236, a user interface 238, a plurality of feature sets 240, a piecewise linear curve component(s) 242, and a market data component 244. The Tradelegs Platform 220 may include one or more additional components and is not limited to the components illustrated in FIG. 2. In addition, one having ordinary skill in the art will appreciate that the components shown in FIG. 2 are presented for illustration purposes, and that embodiments of the Tradelegs Platform 220 may not include each of the illustrated components, but may instead have a variety of different combinations of the illustrated components.

2.1 Securities and Derivatives

For the purpose of this document, a Security is intended to include, but is not limited to, any tradeable asset that underlies other derivative contracts. According to embodiments of the present invention, a derivative is typically an option on the underlying asset (vanilla or exotic), a future, or any other form of contract derived from the underlying Security or basket of Securities. For example, a Security may be a stock, ETF or mutual fund, commodity, fixed-income, currency, bond, or future contract, or may even be an option with its own derivatives. According to an embodiment, Security may be itself a Derivative of another asset, provided that: (1) the Security is tradeable; and (2) the Security underlies other Derivative contracts that can be traded.

A performance prediction curve component 222 may receive and or generate performance prediction curve data. In one embodiment, the performance prediction curve component 222 may generate performance curves. The performance prediction curve component 222 may receive and/or transmit data to any of the components illustrated in FIG. 2. In one embodiment, the user may input a performance prediction curve to pass as input to the optimization component 232. Other input types may be received by the performance prediction curve component. Similarly, the output of the performance prediction curve component may be customized by the user.

2.2 Consolidated Performance Prediction Curve

In one embodiment, an input receivable by the Tradelegs Platform is the User's consolidated performance prediction curve (also referred to as a “Consolidated Performance Prediction Curve”). In an embodiment, the Tradelegs Platform is configured to assist in the generation of these curves based on the User's predictions.

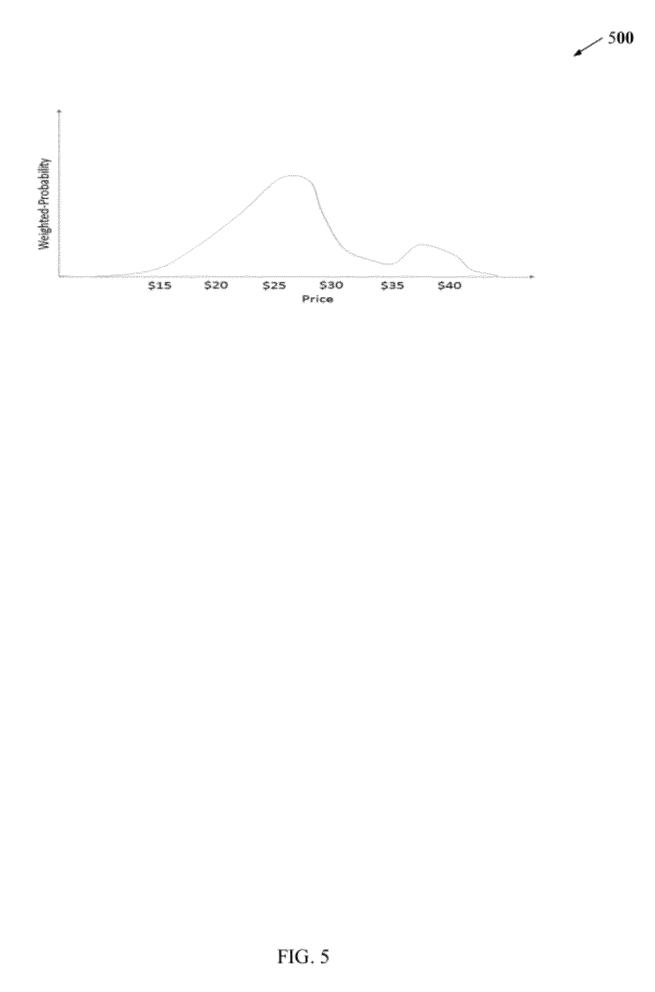

According to embodiments of the present invention, there are two forms of the Consolidated Performance Prediction Curve: 1) a consolidated price performance prediction curve (also referred to as a “Consolidated Price Performance Prediction Curve”); and 2) a consolidated relative performance prediction curve (also referred to as a “Consolidated Relative Performance Prediction Curve”). In an embodiment, the Consolidated Price Performance Prediction Curve is used when the User is making an absolute “price prediction” describing where a security's price will lie at a given Target Date. In an embodiment, the Consolidated Price Performance Prediction Curve describes the weighted-probability of each market price for the security at a user-specified time (e.g., a target date or a target period of time), and consolidates the prediction inputs the User has entered for this security. FIG. 5 illustrates an example consolidated price performance prediction curve 500.

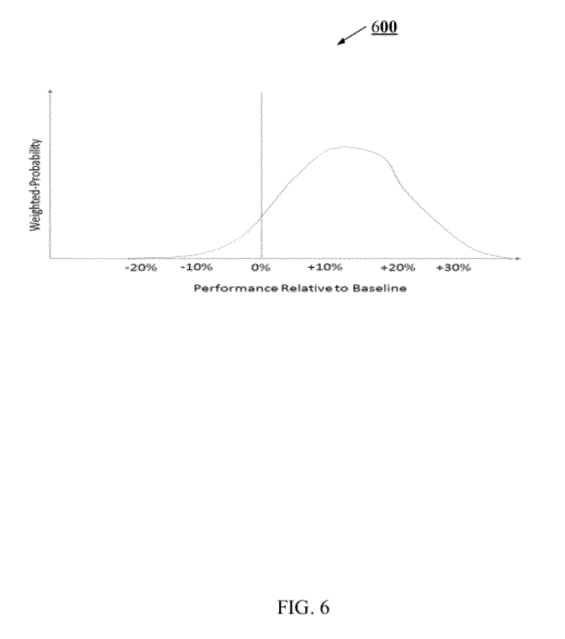

According to embodiments of the present invention, the Consolidated Relative Performance Prediction Curve is used when the User is making a prediction on the performance of a security relative to one or more of a Baseline ETF; an index; another security (e.g., a baseline security); or a baseline security basket (at a given target date or target period). An example for the Consolidated Relative Performance Prediction Curve 600 is presented in FIG. 6.

According to embodiments of the present invention, a Consolidated Performance Prediction Curve is used by the Tradelegs Platform in the financial trade optimization process, to select the most appropriate security and option contracts for the trade, such as, for example, the process described below in connection with FIG. 3.

FIG. 3 illustrates a method 300 of presenting an optimized financial trade position to a user. The method 300 may be implemented or executed by the Tradelegs Platform (e.g., Tradelegs Platform 103 of FIG. 1 or Tradelegs Platform 220 of FIG. 2), in accordance with embodiments of the present invention.

In block 301, the Tradelegs Platform receives optimization inputs relating to a security. According to embodiments of the present invention, the optimization inputs may be received from one or more of the user components (e.g., user computer 104 of FIG. 1), a market information source (e.g., market information source 106 of FIG. 1) and/or one or more of the components of the Tradelegs Platform. According to an embodiment, the optimization inputs include a Consolidated Performance Prediction Curve, a set of financial constraints, market information, and an optimization objective.

In block 302, the Tradelegs Platform determines an optimized financial trade position based on the multiple optimization inputs, and in block 303, the optimized financial trade position is presented to the user. Various aspects and embodiments of the blocks shown in FIG. 3 are described in greater detail below.

According to embodiments of the present invention, the Tradelegs Platform may facilitate the generation of these curves by allowing the User to edit security Predictions and Outcomes as well as their effects on performance. These concepts are defined in the following sections, including, for example, with reference to the method shown in FIG. 4.

In an embodiment, an outcome component 224 receives and/or generates outcome data. For example, the outcome component 224 may generate outcome curves. In one embodiment, the outcome component 224 may receive event driven outcomes and may group these for further processing by the prediction component 226, the performance prediction curve component 222, and the optimization component 232. Other outcome combinations may also be user generated and consolidated for further processing by the user or by a community of users.

2.3 Outcomes

According to embodiments of the present invention, an outcome (also referred to as an “Outcome”) includes any situation that may arise in the future. In an embodiment, an Outcome may be associated with an Occurrence Probability or an Impact-Weight (explained in Section 2.3.2), as well as an Outcome Performance Prediction Curve. Similarly to the consolidated curves derived from them, there are two forms of the Outcome Performance Prediction Curve: (1) an outcome price performance prediction curve (also referred to as an “Outcome Price Performance Prediction Curve”); and (2) an outcome relative performance prediction curve (also referred to as an “Outcome Relative Performance Prediction Curve”), which respectively define the User's predicted absolute or relative price performance for the security, in the event that the Outcome does take place by the given target date.

For example, Pharmaceutical company XXX is waiting to hear if drug D will be approved by the FDA by the target date. The user-predicted probability of an “FDA Approval” outcome is 40%; an “FDA Denial” outcome is 30%; while an “FDA Deferral” (to a later date) outcome is 30%. The percentage notation for probabilities is used throughout this document (a probability of X % denotes a conventional probability of X/100). The Impact-Weight of these alternative outcomes on XXX's share price, relative to other unrelated outcomes, is 9/10.

The Outcome Price-Performance Prediction Curve for one of these outcomes, the “FDA Approval” outcome, is defined by the User to be as follows:

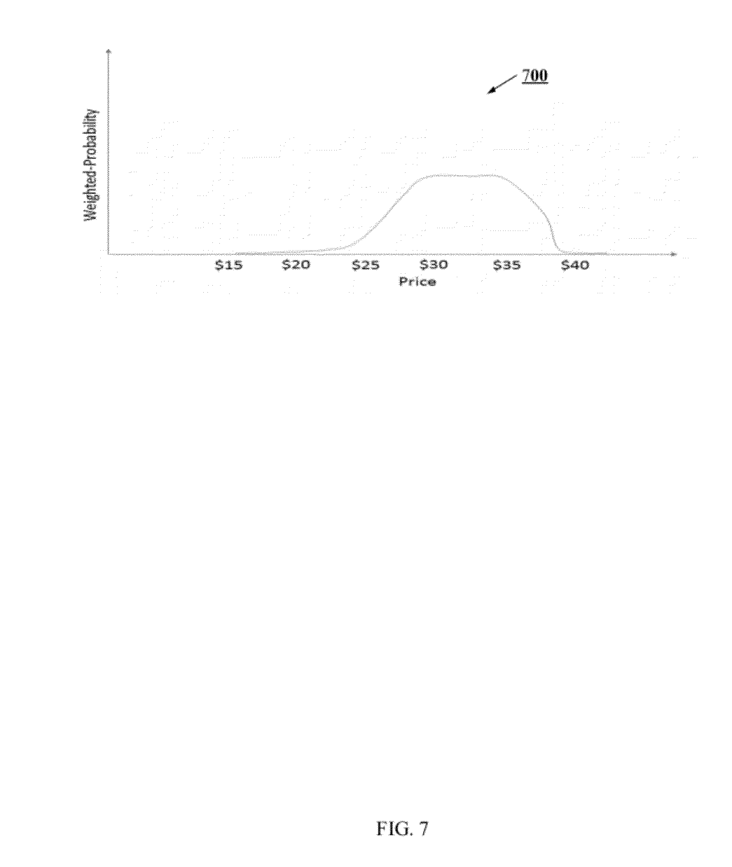

For example, FIG. 7 illustrates an exemplary Outcome Price-Performance Prediction Curve 700. Similar curves are created for the other two alternative outcomes, before they are consolidated into the overall Consolidated Performance Prediction Curve.

FIG. 4 illustrates a method 400 of generating and presenting a Consolidated Performance Prediction Curve to a user. The method 400 may be implemented or executed by the Tradelegs Platform (e.g., Tradelegs Platform 103 of FIG. 1 or Tradelegs Platform 220 of FIG. 2), in accordance with embodiments of the present invention.

In block 401, the Tradelegs Platform receives, from a user, multiple outcome events relating to a security and multiple minimum and maximum performance values associated with user confidence levels for each outcome event. In block 402, the Tradelegs Platform generates multiple outcome prediction curves each corresponding to one of the multiple outcome events based on the multiple minimum and maximum performance values associated with the one of the multiple outcome events. In block 403, the Tradelegs Platform associates each of the multiple outcome prediction curves with a corresponding one of the multiple outcome events. In block 404, the Tradelegs Platform receives a prediction tree including multiple nodes corresponding to one of the multiple outcome events, one or more alternative outcome events, and one or more independent outcome events. In an embodiment, the prediction tree is received from the user. In block 405, the Tradelegs Platform consolidates the multiple nodes into a consolidated performance prediction curve, which is presented to the user in block 406.

2.3.1 Outcome Groups

In an embodiment, to facilitate input and visualization of Outcomes, the User may organize related Outcomes into an Outcome Group. Typically, alternative outcomes are members of a single outcome group.

Outcome Group Example:

The three alternatives from the previous Pharmaceutical company XXX example may be placed into a single outcome group:

| | |
|---|---|
| • | “Drug D FDA Results” Outcome Group = { |

| | |
|---|---|
| | “FDA Approval” Outcome (40% probability) |
| | “FDA Denial” Outcome (30% probability) |
| | “FDA Deferral” Outcome (30% probability) |
| } | |

Outcome Groups may be nested within other, “parent” Outcome Groups, to create a more complex, hierarchical Outcome Tree (also referred to as the Prediction Tree).

2.3.2 Outcome Probabilities and Impact-Weights

The Pharmaceutical outcomes described in the above example illustrated a situation where peer Outcomes or Outcome Groups are alternatives of each other. Whenever this occurs, the User will allocate an Occurrence Probability for each alternative Outcome or Outcome Group that gives the User's view of the probability of outcome occurrence, such that the sum of the alternative outcomes' probabilities adds up to 100%.

However, in certain embodiments, the Outcomes and Outcome Groups may not be alternatives of each other. In such situations, the User may represent the different degrees by which these unrelated or independent Outcomes or Outcome Groups will impact the security's performance. To enable this, Outcome Groups and Outcomes can be associated with Impact-Weights instead of probabilities. When the User assigns higher weights to a high-impact Outcome or Outcome Group, the system will attribute a greater weight to their Outcome Performance Prediction Curves in the Consolidated Performance Prediction Curve.

Impact-Weights Example:

Suppose that Pharma Company XXX now also has a plan to acquire smaller startup Pharma Company yyy. This can be represented as a separate outcome group with a different Impact-Weight:

| | |
|---|---|
| • | “yyy Acquisition” Outcome Group (impact 4/10) = { |
| | “Acquisition Successful” Outcome (70% probability) |
| | “Acquisition Unsuccessful” Outcome (30% probability) |
| } | |
| • | “Drug D FDA Results” Outcome Group (impact 9/10) = { |
| | “FDA Approval” Outcome (40% probability) |
| | “FDA Denial” Outcome (30% probability) |
| | “FDA Deferral” Outcome (30% probability) |
| } | |

As an alternative to impact-weighting, the Outcome Group hierarchical nesting capability provides the User with another approach to predicting security performance when combinations of independent outcomes occur. For example, representing the outcome combination “yyy Acquisition is Successful” AND “Drug D Approval is Denied by the FDA” can be modeled by nesting the Drug D FDA Results Outcome Group inside a parent Outcome Group representing a successful yyy acquisition. Explicit representation of such a combination allows the User to predict performance for this combination, giving the User more granular control, but involves significantly more work: the Outcome Tree size increases rapidly, as each combination leaf will require the User to enter an Outcome Performance Prediction Curve.

According to an embodiment of the present invention, the prediction component 226 may receive and/or generate prediction data. In one embodiment, the user may enter a prediction as a graph, predicting the performance of a given security, company, government entity, by considering all factors in a single outcome prediction, or by making predictions comprising multiple outcomes such as regulation events, market events, corporate situations arising, political events and/or the like. The prediction component may provide a customizable interface for the user to enter predictions. In one embodiment, the customizable interface may include a mobile interface, a tablet interface, a desktop interface and/or a collaborative touchscreen interface. For example, a User may generate a Prediction by inputting the following data:
a Security that is subject to Prediction; Section 5.3 discusses Predictions on Security Baskets, where Users wish to make a Prediction concerning the performance of a group of Securities—a Security Basket is a set of Securities that are combined into a composite security that weights its constituents equally, by market capitalization, or by any other mechanisms such as security price-weighting.
a Confidence-Weight for the Prediction, that allows predictions to be weighted relative to each other by the degree of conviction of the User in the prediction as a whole;
a Target Date on which the predicted performance is expected to occur. One having ordinary skill in the art will appreciate that the term Target Date may include the consideration of trades by the Tradelegs Platform that last one or more days. However, any timescale could have been used without loss of concept and technique generality: the Target Date could be replaced when day trading with a Target Hour, Second, Minute, Month, or Year, for example.
   the Prediction Type (Price Performance, or Relative Performance);
   In the case of Relative Performance the User specifies a Performance Baseline, such as an index, an index ETF or other form of ETF, or any other Security (or Security Basket). The underlying baselines may be subject to the User's Price Performance predictions, to allow the system to take into account the User's view of the Performance Baseline's price probabilities.
a Performance Range that limits the range of possible performance for the purpose of calculating position risk and invested capital. The Performance Range is described by two values: in the case of Price Performance, a minimum and a maximum Security price for the time period from trade entry to the Target Date, while in the case of Relative Performance, a minimum and a maximum percentage describing the widest possible range of relative performance for the same time period;
an Outcome Tree, describing all the Outcome Groups and Outcomes, together with their Probabilities, Impact-Weights;
an Outcome Performance Prediction Curve for each outcome in the Outcome Tree; and
further parameters as needed to allow for options pricing, such as Security/Security Basket Volatility.

Outcome Tree Example:

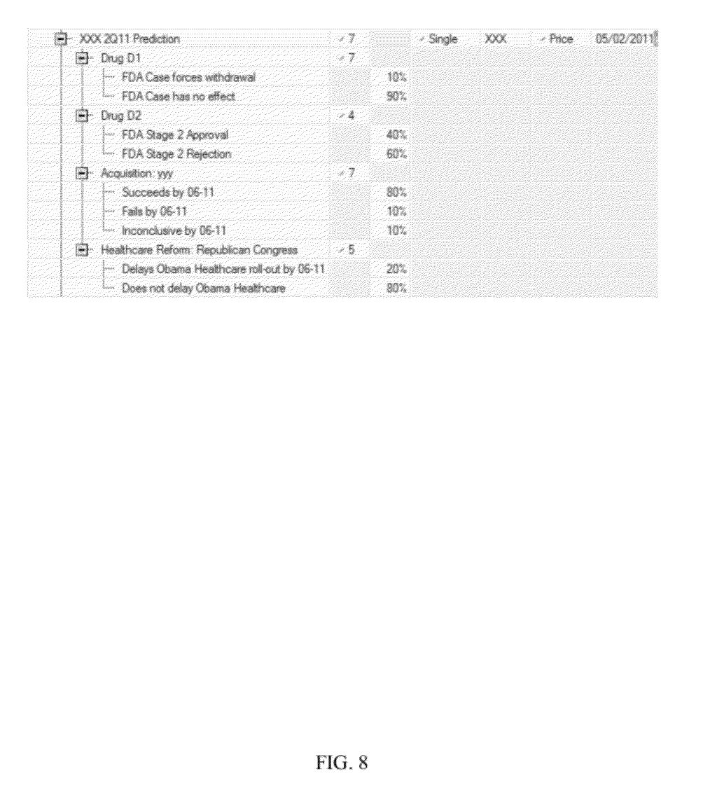

FIG. 8 illustrates a screenshot of Tradelegs Optimization Method and System, that is based, at least in part, on a real-life Pharmaceutical company and several of its products and impacting outcomes.

A scenario component 228 may receive and/or generate scenario data. In one embodiment, the scenario component may receive data from the prediction component and generate data for the optimization component.

2.5 Scenarios

Scenarios are a set of user-input predictions that compete for the same pool of trading capital. The system optimizer will optimize allocation of capital across predictions, taking into account the strength of the User's conviction in different outcomes, as well as market Security and Derivative prices. Security and option/derivative prices for a prediction are most attractive when they are greatly under-priced or over-priced according to the User's prediction. If the User's prediction is correct, the opportunity for profit is higher. The system will prioritize the predictions with the highest profit potential, while satisfying all the various trading constraints.

Multiple Predictions Example:

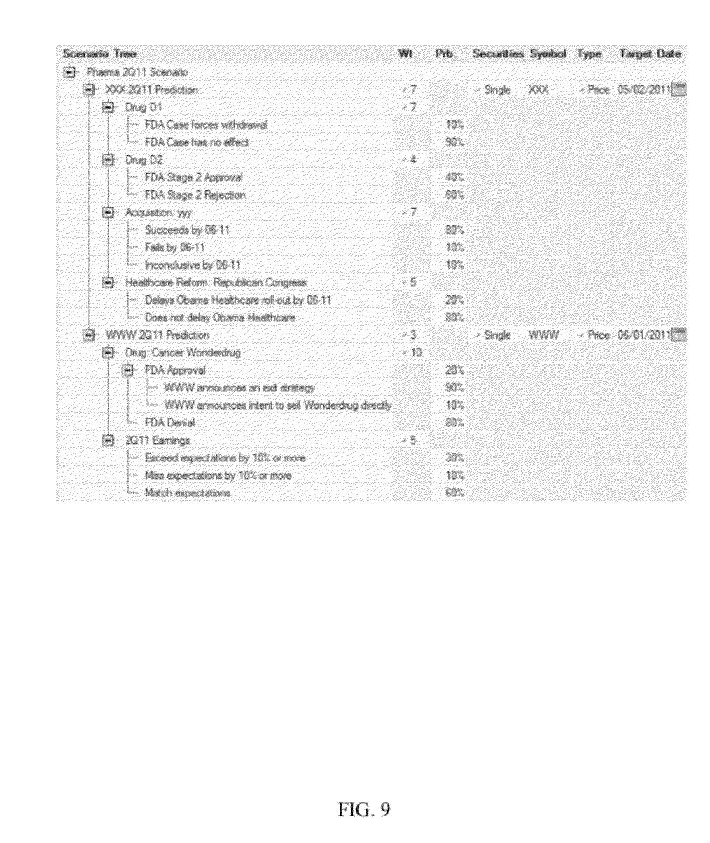

FIG. 9 illustrates a screenshot of a scenario comprising two Pharma predictions competing for the same pool of trading capital (one for company XXX, the other for company WWW).

In an embodiment, a constraints component 230 may receive and/or generate constraint data. In one embodiment, the constraints component allows a user to enter constraints data for consideration by the prediction component, the scenario component, the optimization component and/or any of the other components illustrated in FIG. 2, although other components may also be utilized. The constraints may include temporal, financial, policy and/or rule based constraints. In one embodiment, the user may add or remove constraints to develop hypothetical projections form any of the components illustrated in FIG. 2.

2.6 Trading Constraints

After a Scenario has been entered into the Tradelegs Optimization Method and System, several other areas of input are required before the system's algorithm is in a position to optimize the selection of Securities and Derivative contracts to trade. The following constraints may be entered by the User to ensure the trades generated are executable.

1. Risk Capital: This is a dollar value input variable that communicates to the system the maximum amount of money that may be lost on the recommended trade for a given Scenario. Although the term “dollar value” is used, one having ordinary skill in the art will appreciate that any financial instrument or currency may be used to communicate the amount of funds in the trading pool.

2. Invested Capital: This is a dollar value input variable that communicates to the system the maximum amount of money that may be tied up at any time in the lifetime of the recommended trade for a given Scenario.

3. Position Diversification: These give dollar limits for the maximum amount of Invested Capital and Risk Capital on a per Prediction or per Security basis.

4. Maximum No. of Security Contracts: This is the maximum number of security contracts allowed in the recommended trade.

5. Maximum No. of Option Contracts: This is the maximum number of option contracts allowed in the recommended trade.

6. Maximum No. of Security (or Option) Contracts per Security or Prediction: These are variants of the above constraints that respectively limit the number of Securities/Options contracts per individual Security or Prediction.

7. Maximum No. of Legs: This is the maximum number of Legs (different contract type positions) that can be introduced into the recommended trade.

8. Minimum (Annualized) ROI: This percentage value constrains the minimum return-on-investment, as measured by tied up Invested Capital, over the lifetime of the trade (or annualized).

9. Minimum Profit/Risk Ratio: This limits the minimum acceptable average expected profit to risked capital ratio.

10. Minimum Expected Profitability: This allows the User to enter a minimum dollar limit for the Weighted-Average expected profit.

2.7 Analysis Assumptions

In addition to the constraints limiting the allowed trades, certain assumptions are required to enable the determination of trading costs; to estimate the prices of options contracts at future dates (in particular on the Target Date, when the system assumes the User will exit the recommended trade); and to estimate price slippage with position size due to illiquidity. These are:

1. Transaction Costs: The costs charged by brokers, quoted, for example, as the dollar cost per 100 Securities traded, or per Option Contract.

2. Entry Slippage: This parameter allows the estimation of securities and options contract price slippage on the exit date. For example, it assumes that the headline bid and ask prices are available independent of position size (Best Bid-Ask); assumes the availability of a transparent market Bid-Ask stack (Order Book); or assumes the application of a rule degrading Bid-Ask pricing according to the size of the order, to model market illiquidity (Rule-Based).

3. Exit Slippage: Determines the amount of slippage assumed on the exit date: it assumes either no slippage (None); assumes the same slippage as the entry headline/best bid-ask spread (Entry Bid-Ask Spread); assumes that the slippage estimate for entry should be reused for exit, regardless of which technique is used to estimate entry slippage (Shadow Entry Slippage); or assumes the application of a rule that degrades bid and ask pricing according to the size of the order, to model market illiquidity on the exit date (Rule-Based).

4. Option Pricing Model: Allows the User to determine the pricing model for options in the future, e.g. Black-Scholes Fair Value, or Binomial Fair Value.

5. Risk-free Interest Rate: The interest rate on risk-free treasuries. This is used for Black-Scholes and Binomial models, among others.

6. Volatility: Also required for Black-Scholes and Binomial Fair Value. Allows the User to input a predicted volatility value (Predicted), or request the system to compute the implied volatility per option on entry and use that on other trade dates (Implied).

An optimization component 232 optimizes the selection of security and derivative contracts for the Tradelegs Platform, subject to the User inputs. In one embodiment, the optimization component may start with an initial position. This initial position may be previously instantiated, although the optimization component may receive a clean slate position. The Tradelegs Platform may allow the selection of optimization parameters which give the user the ability to select a given parameter or parameters to perform the optimization.

2.8 Optimization Criteria

In one embodiment, the Scenario's Predictions give the System the User's view on how security prices will perform; the Trading Constraints may limit the possible trades that may be generated by the system to model the realities of the User's account and other practical considerations such as position size; and the Analysis Assumptions enable the estimation of trading costs, securities and options pricing at future dates, and the detrimental effect of illiquidity (slippage).

What remains is to communicate to the system what the algorithm should focus on optimizing. Several alternative objectives are available, and are described below:

1. Max(Profit): Maximize the average expected profit, weighted by the Security performance probabilities calculated for the input Scenario (captured by the Consolidated Performance Prediction Curves), while factoring in the top-level Prediction Impact-Weights.

2. Max(ROI) and Max(Annualized ROI): Maximize the ROI on the Invested Capital over the lifetime of the trade, or the annualized ROI. These maximization algorithms take into consideration not only the profit, but also the amount of the Invested Capital tied up by the trade, and how long it is tied up for.

3. Max(Profit/Risk Ratio): This parameter may be used by Users who want to maximize return on risked capital.

2.9 Optimization Algorithm and Reports

After entering the above information, the User is in a position to submit a request to its algorithm to compute an optimal or good quality recommended trade that will maximize the selected Optimization Criterion subject to the User's Scenario Predictions, Trading Constraints and Analysis Assumptions. The trade is reported as a set of Trade Legs:

A Trade Leg is defined as a buy-to-open or sell-to-open Order for a specific Contract at a specified Open Date (i.e. entry date); a contract Quantity sizing the order; and a specified Close Date (i.e. exit date). Each Trade Leg is associated with a given Prediction.

The trade result and its analysis are displayed in a series of interactive and archived reports, and, after review, the User may attempt to execute the trade, usually with much better derivative trade accuracy and profitability, as well as capital efficiency, than other alternative, less automated approaches.

A domain model component 234 manages the system model for the problem domain in its entirety including the objects, the data and their relations. The domain model may communicate, receiving and/or transmitting data to the prediction component, the optimization component and/or the like. In one embodiment, the domain model may pre-process or receive pre-processed data from any of the components and/or entities illustrated in FIGS. 1 and 2.

3.1 Overview

In this section, the model and the algorithms that produce the Trade Legs that optimize the user-specified optimization criteria are described. This section focuses on the domain model and algorithms.
Section 3.2 describes the model objects (variables and constants).
Section 3.3 describes the pre-processing stage and provides additional detail on the objects generated during the preprocessing stage (the payoff, expected payoff curves, and the average expected payoff).
Section 3.4 describes the model.
Section 3.5 describes how the model is adapted in order to be expressed as a problem addressable by the mathematical solver component, specifically, in this embodiment, as a Mixed Integer Programming (MIP) problem, and show how a Mixed Integer Programming Solver can be used to optimize the non-linear model.

3.2 Model Objects

The following table describes all the model objects (variables and constants). The following conventions are used:
Variables are denoted by italic font, and start with uppercase characters (e.g. Quantityₜ^{leg}).
Constants are denoted by regular font, and start with uppercase characters (e.g. Targetₚ^{pred}).
Sets are denoted by a single character and use italics font (e.g. P).
Functions are denoted by regular font, and start with lowercase characters (e.g., payoffₜ^{leg}(v,Date,Vol)).
Superscripts denote a variant of the object (e.g. EntryQty_{t,l}^{leg} refers to the entry quantity of a trade leg (leg)).
Subscripts denote the index: indices are denoted using lowercase characters, while multi-indexed objects have indices separated by commas (e.g., EntryQty_{t,1}^{leg}).

The type of the model object, in this embodiment, can be one of the following types:
Input: this is input directly provided by the User.
System Constant: this is input from the system configured constants.
Preprocessor: this is input to the model that is generated by the preprocessor.
Decision Variable: these are the problem decision variables where search takes place.
Dependent Variable: these are variables that depend on the values of the decision variables.

The data type of the model object is also shown in brackets (Set, String, Date, Real, Integer, Function, etc.).

The data type of the model object is also shown in brackets (Set, String, Date, Real, Integer, Function, etc.).

| Model object | Description | Type |
|---|---|---|
| P | Set of Predictions in the User scenario. | Input (Set) |
| Secₚ^{pred}, p ∈ P | The Security or Security Basket that is | Input (String) |
| | subject to Prediction p ∈ P. | |
| TargetDateₚ^{pred}, p ∈ P | a Target Date on which the predicted | Input (Date) |
| | performance is expected to occur for p ∈ P. | |
| Minₚ^{pred}, p ∈ P | The minimum of the Performance Range | Input (Real ≧ 0) |
| | that limits the range of possible performance | |
| | for the purpose of calculating position risk | |
| | and invested capital for p ∈ P. | |
| Maxₚ^{pred}, p ∈ P | The maximum of the Performance Range | Input (Real ≧ 0) |
| | that limits the range of possible performance | |
| | for the purpose of calculating position risk | |
| | and invested capital for p ∈ P. | |
| π | Performance increment p ∈ P. | System Constant |
| | | (Real ≧ 0) |
| Vₚ, p ∈ P | Set of performance range values for | Preprocessor (Set) |
| | Prediction. | |
| | ${V}_{p} = \{ \begin{matrix}{Min}_{p}^{pred} , {Min}_{p}^{pred} + π , \\ {Min}_{p}^{pred} + 2 π , … , {Max}_{p}^{pred}\end{matrix} \} , p ∈ P$ | |
| Wtₚ^{pred}, p ∈ P | A Confidence-Weight for Prediction p ∈ P. | Input (Integer ≧ 0) |
| TargetVolₚ^{pred}, p ∈ P | Security/Security Basket Volatility at the | Input (Percent ≧ 0) |
| | TargetDateₚ^{pred}. | |
| MinVolₚ^{pred}, p ∈ P | Security/Security Basket assumed minimum | Input (Percent ≧ 0) |
| | Volatility between current and | |
| | TargetDateₚ^{pred}. | |
| MaxVolₚ^{pred}, p ∈ P | Security/Security Basket assumed | Input (Percent ≧ 0) |
| | maximum Volatility between current | |
| | and TargetDateₚ^{pred}. | |
| probₚ^{pred}(v), v ∈ Vₚ, p ∈ P | A weighted-probability function that defines | Input (Function: |
| | the Consolidated Performance Prediction | Real → Real) |
| | Curve generated out of the Outcomes' | |
| | Performance Prediction Curves, representing | |
| | the consolidated User opinion on Security | |
| | performance. The User provides the | |
| | information above using the Scenario Editor | |
| | described in Section 4.1, and the system | |
| | generates the Prediction's Consolidated | |
| | Performance Prediction Curve from this | |
| | input. This is represented as a Piecewise | |
| | Linear Curve. Piecewise Linear Curves and | |
| | useful operations on them are described | |
| | below. In an embodiment, Piecewise-Linear | |
| | Curves are utilized to facilitate the | |
| | generation of a solution by Linear | |
| | Programming-based methods such as MIP, | |
| | without a significant loss of generality. | |
| | However, non-linear and non-Piecewise- | |
| | Linear curves could have been used to | |
| | instantiate this concept, in combination with | |
| | other algorithms. | |
| C | This set specifies the contracts that are | Input (Set) |
| | available to the optimization algorithm for | |
| | inclusion in the trade. | |
| SecType_{c}^{contr}, c ∈ C | The contract “Type”. A contract can be a | Input (String) |
| | ‘security’ (stock, ETF, future, . . . ), or an | |
| | ‘option’ (call or put) for an underlying | |
| | Security with a specific strike price and | |
| | expiration date. | |
| Sec_{c}^{conrtr}, c ∈ C | Underlying Security for contract c ∈ C. | Input (String) |
| LotSize_{c}^{contr}, c ∈ C | The size of the underlying Security | Input (Integer ≧ 0) |
| | contracts. For stocks this is normally 1, | |
| | while for futures and options lot size varies. | |
| Strike_{c}^{contr}, c ∈ C | Strike price for contract. | Input (Real ≧ 0) |
| Date_{c}^{contr}, c ∈ C | Expiration date for contract. | Input (Date) |
| Ask_{c,0}^{contr}, c ∈ C | The headline (best) ask price for the | Input (Real ≧ 0) |
| | contract. | |
| AskQty_{c,0}^{contr}, c ∈ C | The headline ask price quantity for the | Input (Integer ≧ 0) |
| | contract. | |
| Bid_{c,0}^{contr}, c ∈ C | The headline bid price for the contract. | Input (Real ≧ 0) |
| BidQty_{c,0}^{contr}, c ∈ C | The headline bid price quantity for the | Input (Integer ≧ 0) |
| | contract. | |
| Ask_{c,l}^{contr}, c ∈ C | The ask price for the contract for deeper | Input (Real ≧ 0) |
| | levels (l > 0). | |
| AskQty_{c,l}^{contr}, c ∈ C | The ask price quantity for the contract for | Input (Integer ≧ 0) |
| | deeper levels (l > 0). | |
| Bid_{c,l}^{contr}, c ∈ C | The bid price for the contract for deeper | Input (Real ≧ 0) |
| | levels (l > 0). | |
| BidQty_{c,l}^{contr}, c ∈ C | The bid price quantity for the contract for | Input (Integer ≧ 0) |
| | deeper levels (l > 0). | |
| L_{c}, c ∈ C | The set of integers ({0, 1, 2, . . . , MaxLevel}) | Input (Set) |
| | corresponding to the levels of bid and ask | |
| | prices for the specified contract as found in | |
| | the market data.. In an embodiment, it is | |
| | assumed that the levels are equal for both, | |
| | but this assumption can be relaxed without | |
| | loss of functionality. | |
| L^{user} | The set of integers levels ({0, 1, 2, . . . , | Input (Set) |
| | UserMaxLevel}) corresponding to the levels | |
| | of bid and ask prices as specified by the | |
| | User for Rule-Based slippage calculations. | |
| | This applies to all contracts. The User only | |
| | needs to input the UserMaxLevel that | |
| | applies to all contracts but this parameter | |
| | could be made contract-specific. | |
| S | Set of underlying securities for all | Input (Set) |
| | Predictions. | |
| | S = {Secₚ^{pred}:p ∈ P} | |
| D | Set of target dates for all Predictions. | Input (Set) |
| | D = {Dateₚ^{target}:p ∈ P} | |
| Dₛ, s ∈ S | Set of target dates for Security s ∈ S. | Input (Set) |
| | Dₛ = {Dateₚ^{target}:Secₚ = s, p ∈ P}, s ∈ S | |
| Pₛ, s ∈ S | Set of Predictions for Security s ∈ S. | Input (Set) |
| | Pₛ = {p:Secₚ = s, p ∈ P}, s ∈ S | |
| Vₛ, s ∈ S | Set of performance range values for all Predictions relating to Security s. ${v}_{s} = {U}_{p ∈ {P}_{s}} {V}_{p} , s ∈ S$ | Input (Set) |
| MaxCapRisk^{total} | Risk Capital Limit. | Input (Real) |
| MaxCapRiskₛ^{sec}, s ∈ S | Risk Capital per Security. | Input (Real) |
| MaxCapRiskₚ^{pred}, p ∈ P | Risk Capital per Prediction. | Input (Real) |
| MaxCapInv^{total} | Invested Capital Limit. | Input (Real) |
| MaxCapInvₛ^{sec}, s ∈ S | Invested Capital per Security. | Input (Real) |
| MaxCapInvₚ^{pred}, p ∈ P | Invested Capital per Prediction. | Input (Real) |
| MaxSecContr^{total} | Maximum Number of Security Contracts. | Input (Integer ≧ 0) |
| MaxSecContrₛ^{sec}, s ∈ S | Maximum Number of Security Contracts per | Input (Integer ≧ 0) |
| | Security s ∈ S. | |
| MaxSecContrₚ^{pred}, p ∈ P | Maximum Number of Security Contracts per | Input (Integer ≧ 0) |
| | Prediction. | |
| MaxOptContr^{total} | Maximum Number of Option Contracts. | Input (Integer ≧ 0) |
| MaxOptContrₛ^{sec}, s ∈ S | Maximum No. of Option Contracts per | Input (Integer ≧ 0) |
| | Security s ∈ S. | |
| MaxOptContrₚ^{pred}, p ∈ P | Maximum No. of Option Contracts per | Input (Integer ≧ 0) |
| | Prediction. | |
| MaxLegs | Maximum Number of Legs. | Input (Integer ≧ 0) |
| MinROI | Minimum ROI. | Input (Percent ≧ 0) |
| MinROI^{annual} | Minimum Annualized ROI. | Input (Percent ≧ 0) |
| MinPRRatio | Minimum Profit/Risk Ratio. | Input (Percent ≧ 0) |
| MinExpProf | Minimum Expected Profitability. | Input (Real ≧ 0) |
| RFIntRate | Average Risk-free Interest Rate. | Input (Percent ≧ 0) |
| MinRFRate | Minimum Risk-free Interest Rate. | Input (Percent ≧ 0) |
| MaxRFRate | Maximum Risk-free Interest Rate. | Input (Percent ≧ 0) |
| TransCost | Transaction costs per 100 shares. The model | Input (Real ≧ 0) |
| | can be extended to deal with more | |
| | complicated transaction cost structures, | |
| | however that requires additional User input. | |
| EntrySlippageModel | Specifies the model to be used for entry | Input (String) |
| | slippage calculations. One of: ‘Best Bid- | |
| | Ask’; ‘Order Book’; ‘Rule-Based’. | |
| ExitSlippageModel | Specifies the model to be used for exit | Input (String) |
| | slippage calculations. One of: ‘None’; ‘Entry | |
| | Bid-Ask Spread’; ‘Shadow Entry Slippage’; | |
| | ‘Rule-Based’. | |
| OptionPricingModel | Specifies the model to be used for option | Input (String) |
| | pricing. One of: ‘Intrinsic Value’; ‘Black- | |
| | Scholes’; ‘Binomial Model’. | |
| VolatilityType | Specifies the type of volatility to be used for | Input (String) |
| | option pricing. One of: ‘Predicted’; | |
| | ‘Implied’. | |
| OptimizationCriterion | Specifies the criterion that will be optimized | Input (String) |
| | by the solver. One of: ‘Max(Profit)’; | |
| | ‘Max(ROI)’; ‘Max(Annualized ROI)’; | |
| | ‘Max(Profit/Risk Ratio)’. | |
| Date^{current} | Current (Market Data) date. | Input (Date) |
| Days^{year} | Days per year. | System Constant |
| | | (Integer ≧ 0) |
| SlippageRuleSecVal | Quantity of bought/sold Security contracts | Input (Integer ≧ 0) |
| | after which the price is increased by 1%. | |
| | Used in Rule-Based slippage calculations. | |
| SlippageRuleOptVal | Quantity of bought/sold option contracts | Input (Integer ≧ 0) |
| | after which the price is increased by 1%. | |
| | Used in Rule-Based slippage calculations. | |
| T | Set of tradeable Trade Legs. Where a | Preprocessor (Set) |
| | contract can be selected for multiple | |
| | Predictions, a separate Trade Leg is | |
| | generated for each Prediction. | |
| Secₜ^{leg}, t ∈ T | Underlying Security (or Security Basket) for | Preprocessor |
| | Trade Leg. | (String) |
| Predₜ^{leg}, t ∈ T | Prediction for Trade Leg. | Preprocessor |
| TargetDateₜ^{leg}, t ∈ T | Target date for Trade Leg. | Preprocessor (Date) |
| Contrₜ^{leg}, t ∈ T | Contract for Trade Leg. | Preprocessor |
| LotSizeₜ^{leg}, t ∈ T | Lot size for Trade Leg. Thus is inherited | Preprocessor |
| | from the Trade Leg's Contract. | (Integer ≧ 0) |
| Wtₜ^{leg}, t ∈ T | Confidence-Weight for Trade Leg. This is | Preprocessor |
| | inherited from the Trade Leg's Prediction. | (Integer ≧ 0) |
| Quantityₜ^{leg}, t ∈ T | Target Date exit Quantity for Trade Leg. | Decision Variable |
| | Note that on initial trade entry, the Quantity | (Integer ≧ 0) |
| | is the same for Trade Leg entry. | |
| payoffₜ^{leg} (v, Date, Vol, RFRate), | Payoff function for Trade Leg t ∈ T that | Preprocessor |
| t ∈ T | takes as its parameters: | (Function: (Real, Date, |
| | underlying security price | Percentage, Percent- |
| | v ∈ Vₚ , where p = Predₜ^{leg} | age) → Real) |
| | date (Date) (e.g. TargetDateₜ^{leg}) | |
| | volatility (Vol) (e.g. | |
| | TargetVolₚ^{pred} ) | |
| | risk-free interest rate (e.g. | |
| | RFIntRate) | |
| AvgExpPayoffₜ^{leg}, t ∈ T | The average expected payoff for Trade Leg. | Preprocessor (Real) |
| Orderₜ^{leg}, t ∈ T | Indicates whether the Trade Leg is a ‘buy- | Preprocessor |
| | to-open’ or ‘sell-to-open’ order for the | (String) |
| | contract in question. | |
| SecTypeₜ^{leg}, t ∈ T | Indicates whether the Trade Leg contract is | Preprocessor |
| | an option or a security. | (String) |
| OptTypeₜ^{leg}, t ∈ T | Indicates the type of the Trade Leg option | Preprocessor |
| | contract. One of: ‘call’; ‘put’. | (String) |
| Tₛ, s ∈ S | Set of Trade Legs for Security s ∈ S. | Preprocessor (Set) |
| | Tₛ = {t:Secₜ^{leg} = s, t ∈ T}, s ∈ S | |
| Tₚ, p ∈ P | Set of Trade Legs for Prediction p ∈ P. | Preprocessor (Set) |
| | Tₚ = {t:Predₜ^{leg} = p, t ∈ T}, p ∈ P | |
| T_{c}, c ∈ C | Set of Trade Legs for contract c ∈ C | Preprocessor (Set) |
| | T_{c} = {t:Contrₜ^{leg} = c, t ∈ T}, c ∈ C | |
| Boolₜ^{leg}, t ∈ T | Indicates whether the Trade Leg is used or | Dependent Variable |
| | not. | (Boolean) |
| HundredLotsₜ^{leg}, t ∈ T | Indicates quantity of Trade Legs in lots of | Dependent Variable |
| | 100 contracts. | (Integer ≧ 0) |
| EntryQty_{t,t}^{leg}, c = Contrₜ^{leg}, | Quantity for Trade Leg bought/sold at | Dependent Variable |
| t ∈ T, l∈ (L_{c} ∪ L^{user}) | specific market level 1 at entry (Open). | (Integer ≧ 0) |
| Exit Qty_{t,t}^{leg}, c = Contrₜ^{leg}, | Quantity for Trade Leg bought/sold at | Dependent Variable |
| t ∈ T, l ∈ (L_{c} ∪ L^{user}) | specific market level 1 at exit (Close). | (Integer ≧ 0) |
| LevelZeroPriceₜ^{leg}, t ∈ T | A theoretical bid/ask price for order book | Preprocessor |
| | level 0 for Trade Leg t ∈ T. Used in Rule- | (Real ≧ 0) |
| | Based exit slippage computation. | |
| RiskBound^{total} | Maximum risk bound for all Predictions. | Dependent Variable |
| | | (Real) |
| RiskBoundₛ^{sec}, s ∈ S | Maximum risk bound for all Predictions | Dependent Variable |
| | relating to underlying Security s ∈ S. | (Real) |
| RiskBoundₚ^{pred}, p ∈ P | Maximum risk bound for specific Prediction. | Dependent Variable |
| | | (Real) |
| Entry NetCash^{total} | Entry net cash for all Predictions. Note that | Dependent Variable |
| | this factors in Entry Slippage. | (Real) |
| EntryNetCashₛ^{sec}, s ∈ S | Entry net cash for all Predictions relating to | Dependent Variable |
| | underlying Security s ∈ S. Note that this | (Real) |
| | factors in Entry Slippage. | |
| EntryNetCashₚ^{pred}, p ∈ P | Entry net cash for Prediction p ∈ P. Note | Dependent Variable |
| | that this factors in Entry Slippage. | (Real) |
| EntryNetCashₜ^{leg}, t ∈ T | Entry net cash for Trade Leg t ∈ T. | Dependent Variable |
| | | (Real) |
| EntryTransCosts^{total} | Entry transaction costs for all Predictions. | Dependent Variable |
| | | (Real) |
| EntryTransCostsₛ^{sec}, s ∈ S | Entry transaction costs for all Predictions. | Dependent Variable |
| | relating to underlying Security s ∈ S. | (Real) |
| EntryTransCostsₚ^{pred}, p ∈ P | Entry transaction costs for Prediction | Dependent Variable |
| | p ∈ P. | (Real) |
| EntryTransCostsₜ^{leg}, t ∈ T | Entry transaction costs for Trade Leg t ∈ T. | Dependent Variable |
| | | (Real) |
| Exit TransCosts^{total} | Exit transaction costs for all Predictions. | Dependent Variable |
| | | (Real) |
| Exit TransCostsₛ^{sec}, s ∈ S | Exit transaction costs for all Predictions | Dependent Variable |
| | relating to underlying Security s ∈ S. | (Real) |
| Exit TransCostsₚ^{pred}, p ∈ P | Exit transaction costs for Prediction p ∈ P. | Dependent Variable |
| | | (Real) |
| Exit TransCostsₜ^{leg}, t ∈ T | Exit transaction costs for Trade Leg t ∈ T. | Dependent Variable |
| | | (Real) |
| ExitSlippageCosts^{total} | Exit slippage costs for all Predictions. | Dependent Variable |
| | | (Real) |
| ExitSlippageCostsₛ^{sec}, s ∈ S | Exit slippage costs for all Predictions | Dependent Variable |
| | relating to underlying Security s ∈ S. | (Real) |
| ExitSlippageCostsₚ^{pred}, p ∈ P | Exit slippage costs for Prediction p ∈ P. | Dependent Variable |
| | | (Real) |
| ExitSlippageCostsₜ^{leg}, t ∈ T | Exit slippage costs for Trade Leg t ∈ T. | Dependent Variable |
| | | (Real) |
| Investment^{total} | The invested capital for all Predictions. | Dependent Variable |
| | | (Real) |
| Investmentₛ^{sec}, s ∈ S | The invested capital for Predictions relating | Dependent Variable |
| | to underlying Security s ∈ S. | (Real) |
| Investmentₚ^{pred}, p ∈ P | The invested capital for specific Prediction | Dependent Variable |
| | p ∈ P. | (Real) |
| Investmentₜ^{leg}, t ∈ T | The invested capital for specific Trade Leg | Dependent Variable |
| | t ∈ T. | (Real) |
| AvgExpReturn^{total} | The average expected return for all | Dependent Variable |
| | Predictions. | (Real) |
| AvgExpReturnₛ^{sec}, s ∈ S | The average expected return for Predictions | Dependent Variable |
| | relating to underlying Security s ∈ S. | (Real) |
| AvgExpReturnₚ^{pred}, p ∈ P | The average expected return for specific | Dependent Variable |
| | Prediction p ∈ P. | (Real) |
| AvgExpReturnₜ^{leg}, t ∈ T | The average expected return for specific | Dependent Variable |
| | Trade Leg t ∈ T. | (Real) |
| AvgExpAnnualReturn^{total} | The average expected annualized return for | Dependent Variable |
| | all Predictions. | (Real) |
| AvgExpAnnualReturnₛ^{sec}, s ∈ S | The average expected annualized return for | Dependent Variable |
| | Predictions relating to underlying Security | (Real) |
| | s ∈ S. | |
| AvgExpAnnualReturnₚ^{pred}, p ∈ P | The average expected annualized return for | Dependent Variable |
| | specific Prediction p ∈ P. | (Real) |
| AvgExpAnnualReturnₜ^{leg}, t ∈ T | The average expected annualized return for | Dependent Variable |
| | specific Trade Leg t ∈ T. | (Real) |

3.3.1 Trade Leg

For each Prediction in the scenario, the preprocessor looks at the Security and Derivative contracts that relate to the Prediction's security; for each relevant contract it generates two new trade leg objects, one for buying the contract and one for selling it. Note, contracts that expire before a Prediction's target date are not considered.

According to an embodiment, a “Trade Leg” includes, but is not limited to, a buy-to-open or sell-to-open Order for a specific Contract at a specified Open Date (i.e. entry date); a contract Quantity sizing the order; and a specified Close Date (i.e. exit date). According to an embodiment, each Trade Leg is associated with a given Prediction.

The Open Date may be assumed to be the current date, and the Close Date is assumed to be the Target Date of the Prediction the Trade Leg belongs to.

3.3.2 Payoff Curve

Payoff curves may assist with the calculation of expected returns/profit, and for the calculation of invested and risk capital.

For each buy-to-open or sell-to-open Trade Leg a contract curve structure is used. This is created in the pre-processing phase.

For the underlying Security, the contract curve structure is based on the following inputs:
Minimum and maximum value for contract underlying security
Contract (e.g. stock, future, option)

The contract curve structure may generate a piecewise linear (PL) curve that shows the payoff for the contract corresponding to the underlying Security.

In addition, several payoff piecewise linear curves are generated for option contracts. These PL curves may receive the following additional inputs:
Volatility
Risk-free Interest Rate
Date for which the payoff curve is computed

Section 3.4.2.4 lists the payoff curves generated during preprocessing for the options contracts.

Note that payoff curves ignore commissions and fees as well as the cost of entering the position. They show what the payoff is for a single contract when exiting a position. The payoff curve is defined by the payoff function:payoffₜ^{leg}(v,Date,Vol,RFRate), tεT

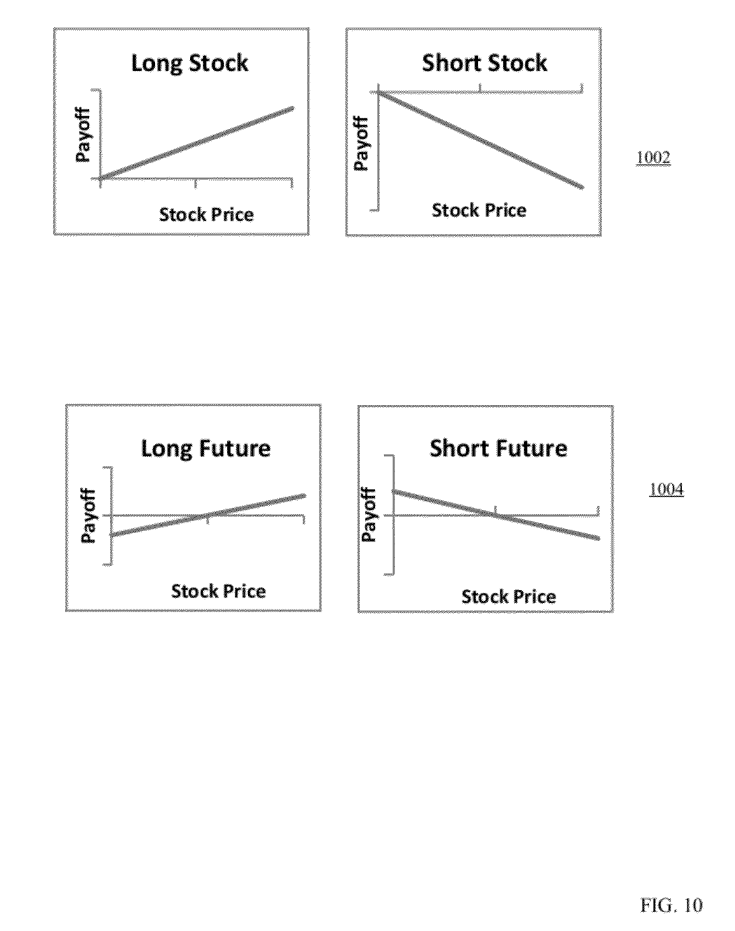

For stocks, the payoff curve may be illustrated as shown in 1002 of FIG. 10.

For futures, the payoff curve may be illustrated as shown in 1004 of FIG. 10.

For options, the payoff curve requires an option pricing method to be used. An option price has two components: Intrinsic Value and Time Value. The option price is the sum of these two components.

The Intrinsic Value of an option depends on the strike price (Strike_{c}^{contr}) and the underlying security price (Priceₛ^{contr}). For a call option the intrinsic value is max[(Price_{Sec}_{_{c}}_{contr}^{contr}−Strike_{c}^{contr}), 0] and for a put option the intrinsic value is max[(Strike_{c}^{contr}−Price_{Sec}_{_{c}}_{contr}^{contr}), 0]. Note that the intrinsic value can never be less than 0.

The Time Value is a premium over and above the intrinsic value that is paid by investors for the right to exercise the option at an improved price before expiration. The Time Value depends on a number of factors including time to expiration date, volatility of the security price, risk-free interest-rate, strike price, underlying security price and dividends expected during the life of an option.

In one embodiment, there may be 3 option pricing methods available to the User:
Intrinsic Value (Expiration Date)
Black-Scholes
Binomial Model

The last two methods include the Time Value of the option. Other pricing methods can be added in a modular way.

The above three methods are explained in the following sections.

3.3.2.1 Intrinsic Value Payoff Curves

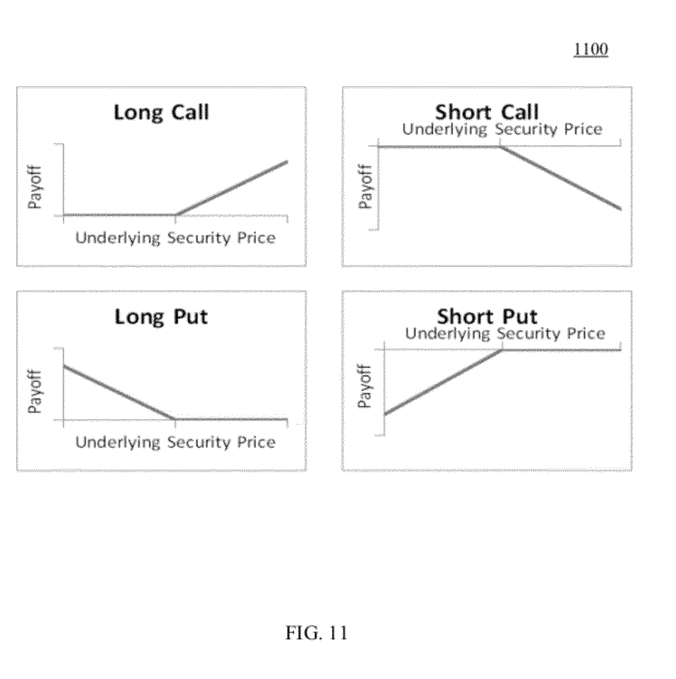

In an embodiment, exemplary payoff curves 1100 using the intrinsic value method (value at expiration date) have the shapes depicted FIG. 11. In each figure, the inflection point corresponds to the option strike price.

3.3.2.2 Black-Scholes Payoff Curves

Black-Scholes is a model for a European option's theoretical price. It makes a number of simplifying assumptions: continuous (or no) dividend payment, constant volatility, and a constant interest rate.

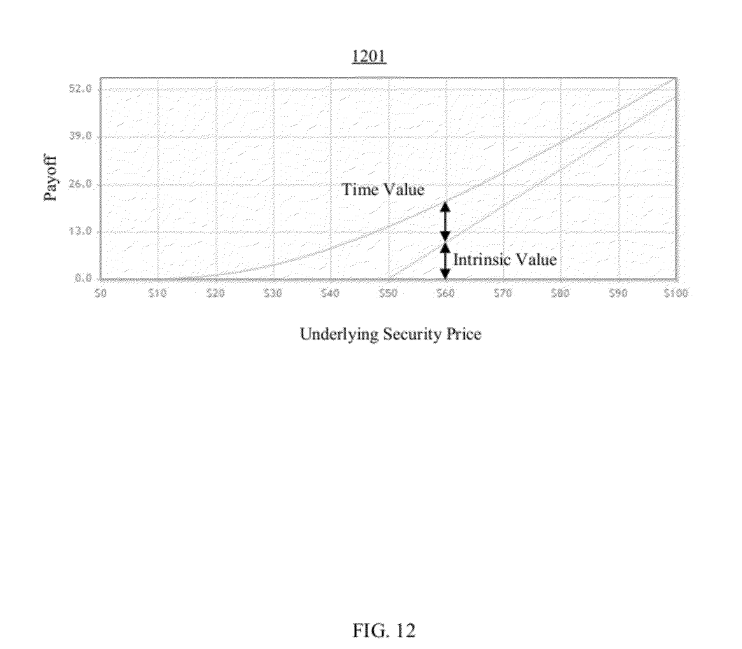

FIG. 12 shows two exemplary payoff curves 1201 for a call with a strike price of 50 expiring in 2 years where the underlying security has volatility of 50% (the risk free interest rate is 1%). One line shows the Black-Scholes pricing which includes a Time Value. The other line shows the intrinsic value (the value on the expiration date).

3.3.2.3 Binomial Model Payoff Curves

Binomial Model values options using a binomial tree. It models the dynamics of the option's theoretical value for discrete time intervals over the option's duration. It is more flexible than the Black-Scholes model and as such it can easily model dividends and American style options.

The Binomial Model may utilize a number of other input parameters:
Number of steps (more steps, better precision)
Initialization method (this relates to the probability of the underlying security price going up vs. going down)

The Binomial Model is used for the valuation of American options. The Binomial Model may be adapted to take into account the possibility of early exercise for American options.

3.3.3 Average Expected Payoff Computation

The optimizer attempts to maximize return/profit (see Section 2.8). All current return optimization criteria require the computation of Average Expected Payoff on the Target Date (AvgExpPayoffₜ^{leg}) for each Trade Leg. This section describes how the preprocessor generates these terms.

(AvgExpPayoffₜ^{leg}) is computed from the relevant Target Date payoff curve for the Trade Leg and the Prediction's (Predₜ^{leg}) Consolidated Performance Prediction Curve for the underlying security (Secₜ^{leg}).

First, the Expected Payoff curve is computed by multiplying the payoff curve by the Prediction's Consolidated Performance Prediction Curve for the Security (Secₜ^{leg}). This results in the Expected Payoff Curve. The average expected payoff (AvgExpPayoffₜ^{leg}) is equal to the sum of the areas between the expected payoff curve and the horizontal axis (areas below the axis are negative).

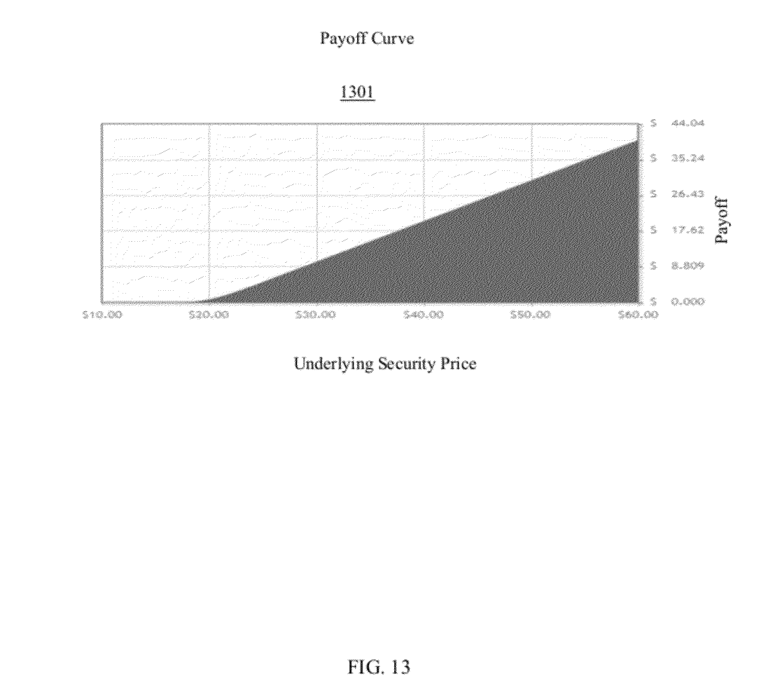

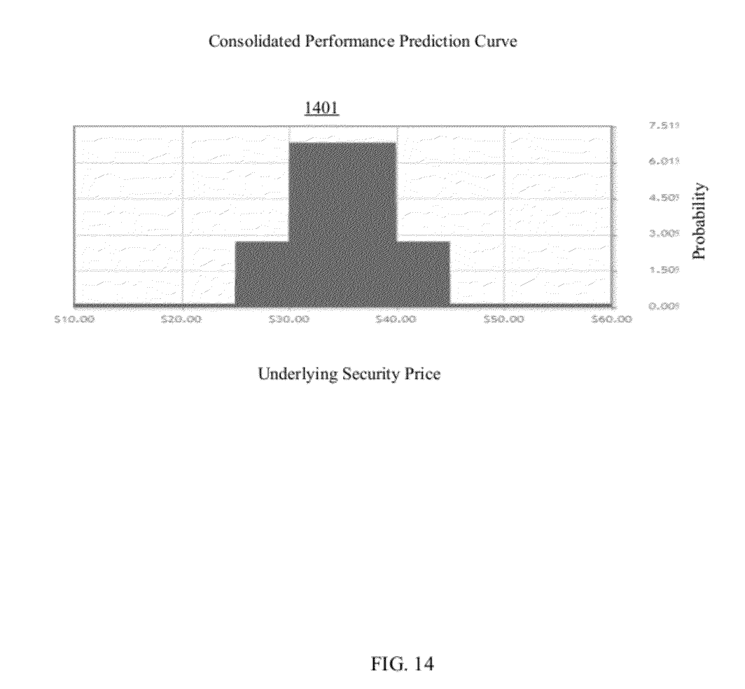

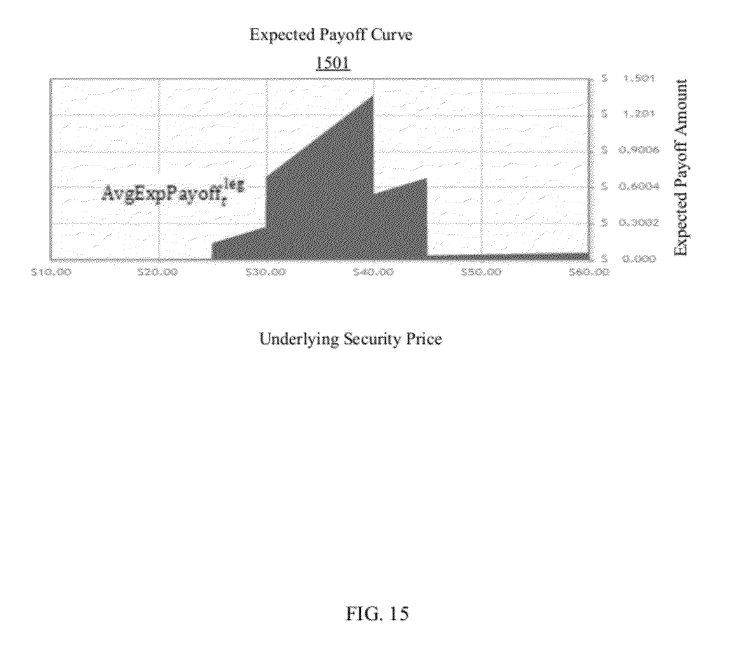

FIGS. 13-15 illustrate exemplary payoff, Consolidated Performance Prediction and Expected Payoff curves for a long call contract. FIG. 13 illustrates an exemplary Payoff Curve 1301. FIG. 14 illustrates an exemplary Consolidated Performance Prediction Curve 1401. FIG. 15 illustrates an exemplary Expected Payoff Curve 1501. When constructing the Expected Payoff Curve, which estimates actual contract payoff by multiplying the user-specified weighted-probability of a price occurring with its impact on P/L, care must be taken to ensure that prediction and payoff curves have points for the same x-values generated for all the points. The x-values set comprises the union of all x-values encountered in the payoff and Consolidated Performance Prediction Curves.

3.4 The Model

In this section we discuss the model used for optimization, reporting and Position Analysis (see Section 5.1).

3.4.1 Formulation

The model is formulated as a Constraint Satisfaction and Optimization Problem (CSOP) that extends the model objects of Section 3.2 with a set of constraints and an optimization function. The resulting CSOP can be solved by a specialized or general purpose CSOP solver.

A Constraint Satisfaction and Optimization Problem (CSOP) is defined by
A set of variables (and constants)
A set of constraints
An optimization function

The objective of a Constraint Satisfaction and Optimization Solver is to find a solution to the CSOP problem that maximizes or minimizes the optimization function while satisfying the set of constraints.

3.4.2 Constraints

The following constraints relate the model objects.

3.4.2.1 Entry Net Cash

For our purposes, Entry Net Cash is the amount paid or received on trade entry, without factoring in entry transaction costs. As such, Entry Net Cash is the money paid or received in exchange for contract purchase or sale, taking into account price degradation due to entry slippage.

The total entry net cash is the sum of the entry net cash for all Securities.

$${EntrNetCash}^{total} = {\sum }_{s ∈ S} {EntryNetCash}_{s}^{se c}$$

The total entry net cash for a Security is the sum of the entry net cash for all the Trade Legs that refer to that Security.

$$∀ s ∈ S \text{:} {EntryNetCash}_{s}^{se c} = {\sum }_{t ∈ {T}_{s}} {EntryNetCash}_{t}^{leg}$$

The total entry net cash for a Prediction is the sum of the entry net cash for all the Trade Legs that refer to that Prediction.

$$∀ p ∈ P \text{:} {EntryNetCash}_{p }^{pred} = {\sum }_{t ∈ {T}_{p}} {EntryNetCash}_{t}^{leg}$$

The entry net cash for a particular Trade Leg is defined according to the specified Entry Slippage Model method.

3.4.2.1.1 EntrySlippageModel=‘Best Bid-Ask’ Case

In this case the best bid/ask quote for the Security is taken depending on whether the Trade Leg is being sold or bought.

The entry net cash term is:

Constraint Set 1: Best Bid-Ask Entry Costs

∀tεT,c=Contrₜ^{leg}:

(Orderₜ^{leg}=buy-to-open)→(EntryNetCashₜ^{leg}=−Ask_{c,0}^{contr}×Quantityₜ^{leg}×LotSizeₜ^{leg})

∀tεT,c=Contrₜ^{leg}:

(Orderₜ^{leg}=sell-to-open)→(EntryNetCashₜ^{leg}=Bid_{c,0}^{contr}×Quantityₜ^{leg}×LotSizeₜ^{leg})

When the Trade Leg is bought the ask price is negated to reflect that cash is debited.

3.4.2.1.2 EntrySlippageModel=‘Order Book’ Case

Variables EntryQty_{t,l}^{leg} are created, one for each level in the order book. This variable indicates how many contracts are bought/sold at each level in the order book.

In this case, the set L_{c} gives the levels in the order book:

∀tεT,c=Contrₜ^{leg},∀lεL_{c}:

(Orderₜ^{leg}=buy-to-open)→(0≦EntryQty_{t,l}^{leg}≦AskQty_{c,l}^{contr})

∀tεT,c=Contrₜ^{leg},∀lεL_{c}:

(Orderₜ^{leg}=sell-to-open)→(0≦EntryQty_{t,l}^{leg}≦BidQty_{c,l}^{contr})

The sum of the contracts bought/sold over all levels is equal to the total number of contracts bought/sold for that Trade Leg.

$$∀ ∈ T , c = {Contr}_{t}^{leg} \text{:}$$

$${\sum }_{l ∈ {L}_{c}} {EntryQty}_{t , l}^{leg} = {Quantity}_{t}^{leg}$$

Thus, the entry net cash term is given by:

Constraint Set 2: Order Book Entry Costs

$$∀ t ∈ T , c = {Contr}_{t}^{leg} \text{:}$$

$$( {Order}_{t}^{leg} = buy \text{-} to \text{-} open ) -> \\ ( {EntryNetCash}_{t}^{leg} = - {LogSize}_{t}^{leg} \times {\sum }_{1 ∈ {L}_{c}} {EntryQty}_{t , l}^{leg} \times {Ask}_{c , l}^{contr} )$$

$$∀ t ∈ T , c = {Contr}_{t}^{leg} \text{:} \\ ( {Order}_{t}^{leg} = sell \text{-} to \text{-} open ) -> \\ ( {EntryNetCash}_{t}^{leg} = {LotSize}_{t}^{leg} \times {\sum }_{l ∈ {L}_{c}} {EntryQty}_{t , l}^{leg} \times {Big}_{c , l}^{contr} )$$

The following constraints make sure that quantities for the same contract bought/sold for a different Prediction (but same underlying Security) are accounted from the same order book:

Constraint Set 3: Same Contract for Multiple Predictions

$$∀ c ∈ C , ∀ l ∈ {L}_{c} \text{:}$$

$${\sum }_{t ∈ {T}_{c} , {Order}_{t}^{leg} = buy \text{-} to \text{-} open} {EntryQty}_{t , l}^{leg} \leq {AskQty}_{c}^{contr}$$

$$∀ c ∈ C , ∀ l ∈ {L}_{c} \text{:}$$

$${\sum }_{t ∈ {T}_{c} , {Order}_{t}^{leg} = sell \text{-} to \text{-} open} {EntryQty}_{t , l}^{leg} \leq {BidQty}_{c}^{contr}$$

3.4.2.1.3 EntrySlippageModel=‘Rule-Based’ Case

In this case, the User provides three values that determine how entry slippage is estimated:

(1) the UserMaxLevel defining the set L^{user}={0, 1, . . . UserMaxLevel};

(2) the number of Security contracts after which entry slippage increases by X % of the quoted bid/ask price; and

(3) the number of Option contracts after which entry slippage increases by X % of the quoted bid/ask price.

According to an embodiment, it is assumed by default that X=1% unless the User reconfigures this value.

For securities:

∀tεT, c=Contrₜ^{leg}, ∀lεL^{user}:

(SecTypeₜ^{leg}=security)→(0≦EntryQty_{t,l}^{leg}≦SlippageRuleSecVal)

For options,

∀tεT, c=Contrₜ^{leg}:

(SecTypeₜ^{leg}=option)→(0≦EntryQty_{t,l}^{leg}≦SlippageRuleOptVal)

$$∀ t ∈ T , c = {Contr}_{t}^{leg} \text{:}$$

$${\sum }_{l ∈ {L}^{user}} {EntryQty}_{t , l}^{leg} = {Quantity}_{t}^{leg}$$

Thus, the entry net cash term is:

$$∀ t ∈ T , c = {Contr}_{t}^{leg} \text{:}$$

$$( {Order}_{i}^{leg} = buy \text{-} to \text{-} open ) -> \\ ( \begin{matrix}{EntryNetCash}_{t}^{leg} = - {LogSize}_{t}^{leg} \times \\ {\sum }_{l ∈ {L}^{user}} {EntryQty}_{t , l}^{leg} \times ( 1 + ( X / 100 ) \times l ) \times {Ask}_{c , l}^{contr}\end{matrix} )$$

$$∀ t ∈ T , c = {Contr}_{t}^{leg} \text{:}$$

$$( {Order}_{t}^{leg} = sell \text{-} to \text{-} open ) -> \\ ( \begin{matrix}{EntryNetCash}_{t}^{leg} = {LotSize}_{t}^{leg} \times \\ {\sum }_{l ∈ {L}^{user}} {EntryQty}_{t , l}^{leg} \times ( 1 + ( X / 100 ) \times l ) \times {Bid}_{c , l}^{contr}\end{matrix} )$$

The system also generates constraints corresponding to those described in Constraint Set 3: Same Contract for Multiple Predictions (L^{user} replaces L_{c} in the constraint).

3.4.2.2 Exit Slippage Costs

These costs model the degradation of prices due to slippage at the Target Date.

Exit Slippage Costs are additive. In an embodiment, the total exit slippage costs are the sum of the exit slippage costs for all securities.

$${ExitSlippageCosts}^{total} = {\sum }_{s ∈ S} {ExitSlippageCosts}_{s}^{se c}$$

In an embodiment, the total exit slippage costs for a security are the sum of the exit slippage costs for all the Trade Legs that refer to that Security.

$$∀ s ∈ S \text{:} {ExitSlippageCost}_{s}^{se c} = {\sum }_{t ∈ {T}_{s}} {ExitSlippageCosts}_{t}^{leg}$$

The total exit slippage costs for a Prediction is the sum of the exit slippage costs for all the Trade Legs that refer to that Prediction.

$$∀ p ∈ P \text{:} {ExitSlippageCosts}_{p}^{pred} = {\sum }_{t ∈ {T}_{p}} {ExitSlippageCosts}_{t}^{leg}$$

The exit slippage costs for a particular Trade Leg are defined according to the specified method. These are explained below.

3.4.2.2.1 ExitSlippageModel=‘None’ Case

If the method is set to none then all exit slippage costs are 0.

3.4.2.2.2 ExitSlippageModel=‘Entry Bid-Ask Spread’ Case

If exit slippage is based on the current bid-ask spread, then for each Trade Leg the corresponding slippage is computed as follows:

Constraint Set 5: Entry Bid-Ask Spread Exit Slippage Costs

∀tεT, c=Contrₜ^{leg}:

$$∀ t ∈ T , c = {Contr}_{i}^{leg} \text{:}$$

$${ExitSlippageCosts}_{t}^{leg} = \frac{1}{2} ( {Big}_{c , 0}^{contr} - {Ask}_{c , 0}^{contr} ) \times {LotSize}_{t}^{leg} \times {Quantity}_{t}^{leg}$$

Note that the ask price is always greater than or equal to the bid price (i.e. Ask_{c,0}^{contr}≦Bid_{c,0}^{contr} always holds) and therefore slippage (ExitSlippageCostsₜ^{leg}) is always non-positive.

3.4.2.2.3 ExitSlippageModel=‘ Shadow Entry Slippage’ Case

This setting assumes that the exit slippage of a Trade Leg is equal to the computed entry slippage.

∀tεT, c=Contrₜ^{leg}:

(Orderₜ^{leg}=buy-to-open)→(ExitSlippageCostsₜ^{leg}=Ask_{c,0}^{contr}×LotSizeₜ^{leg}×Quantityₜ^{leg}+EntyNetCashₜ^{leg})

∀tεT, c=Contrₜ^{leg}:

(Orderₜ^{leg}=sell-to-open)→(ExitSlippageCostsₜ^{leg}=EntryNetCashₜ^{leg}−Bid_{c,0}^{leg}×LotSizeₜ^{leg}×Quantityₜ^{leg})

3.4.2.2.4 ExitSlippageModel=‘Rule-Based’ Case

In this case, the User provides three values that determine how exit slippage is estimated:

(1) the UserMaxLevel defining the set {0, 1, . . . UserMaxLevel};

(2) the number of Security contracts after which exit slippage increases by Y % of the quoted bid/ask price; and

(3) the number of Option contracts after which exit slippage increases by Y % of the quoted bid/ask price.

According to an embodiment, it is assumed by default that Y=1% unless the User reconfigures this value.

For securities:

∀tεT,∀lεL^{user}:(SecTypeₜ^{leg}=security)→(ExitQty_{t,l}^{leg}→SlippageRuleSecVal)

For options:

$$∀ t ∈ T , ∀ l ∈ {L}^{user} \text{:} ( {SecType}_{t}^{leg} = option ) -> ( {ExitQty}_{t , l}^{leg} \leq SlippageRuleOptVal )$$

$$∀ t ∈ T \text{:} {\sum }_{l ∈ {L}^{user}} {ExitQty}_{t}^{leg} = {Quantity}_{t}^{leg}$$

According to an embodiment, a theoretical bid/ask price is constructed for order book level 0 for each Trade Leg. Subsequent levels are derived from this base level.

Constraint Set 6: Theoretical Bid/Ask Price at Target Date

$$∀ t ∈ T , c = {Contr}_{t}^{leg} \text{:}$$

$$( {Order}_{t}^{leg} = buy \text{-} to \text{-} open ) -> {LevelZeroPrice}_{t}^{leg} = \vert {AvgExpPayoff}_{t}^{leg} \vert \times ( 1 - ( \frac{Y}{100} ) )$$

$$( {Order}_{t}^{leg} = sell \text{-} to \text{-} open ) -> {LevelZeroPrice}_{t}^{leg} = \vert {AvgExpPayoff}_{t}^{leg} \vert \times ( 1 + ( \frac{Y}{100} ) )$$

Since the average expected payoff can be positive as well as negative, the absolute value of AvgExpPayoffₜ^{leg} is used to make sure that the term LevelZeroPriceₜ^{leg} is positive.

Thus, the exit slippage term for a Trade Leg is:

Constraint Set 7: Rule-Based Exit Slippage Costs

∀tεT:

$$∀ t ∈ T \text{:}$$

$${ExitSlippageCosts}_{t}^{leg} = - {LotSize}_{t}^{leg} \times ( \frac{Y}{100} ) \times {LevelZeroPrice}_{t}^{leg} \times {\sum }_{l ∈ {L}^{user}} {ExitQty}_{t , l}^{leg} \times l$$

3.4.2.3 Transaction Costs

Transaction costs model transaction fees and commission associated with the trade. This section describes the constraint sets for transaction costs.

3.4.2.3.1 Entry Transaction Costs

The total entry transaction costs are the sum of the entry transaction costs for all securities.

$${EntryTransCosts}^{total} = {\sum }_{s ∈ S} {EntryTransCosts}_{s}^{se c}$$

The total entry transaction costs for a security is the sum of the entry transaction costs for all the Trade Legs that refer to that security.

$$∀ s ∈ S \text{:} {EntryTransCosts}_{s}^{se c} = {\sum }_{t ∈ {T}_{s}} {EntryTransCosts}_{t}^{leg}$$

The total entry transaction costs for a Prediction is the sum of the entry transaction costs for all the Trade Legs that refer to that Prediction.

$$∀ p ∈ P \text{:} {EntryTransCosts}_{p}^{pred} = {\sum }_{t ∈ {T}_{p}} {EntryTransCosts}_{t}^{leg}$$

In the simple case where the transaction costs are proportional to the number of contracts the transaction costs term is:

Constraint Set 8: Proportional Transaction Costs

∀tεT: EntryTransCostsₜ^{leg}=TransCost×Quantityₜ^{leg}

In some cases, the transaction costs will be incurred in lots of contracts. For example, suppose that the transaction cost for a security increments in 100 steps. Whether one buys 1 or 100 securities the transaction costs are the same. In one embodiment, many other possible transaction cost models implemented by brokers are available, taking into account other factors, such as, for example, tax. According to embodiments of the present invention, transaction costs can vary by number of securities; be capped at a certain point; or be made to increase in discrete increments, using appropriate linear inequalities over linear and integer variables.

This can be captured by the following constraint group:

∀tεT:(SecTypeₜ^{leg}=security)→(HundredLotsₜ^{leg}=┌Quantityₜ^{leg}/100┐)

∀tεT:(SecTypeₜ^{leg}=option)→(HundredLotsₜ^{leg}=Quantityₜ^{leg})

Then the transaction cost can be expressed in terms of the variable HundredLotsₜ^{leg}

Constraint Set 9: Lot Based Transaction Costs

∀tεT:EntryTransCostsₜ^{leg}=TransCost×HundredLotsₜ^{leg}

3.4.2.3.2 Exit Transaction Costs

It is straightforward to generate the corresponding constraint sets for the exit transaction costs (ExitTransCosts variables replace the corresponding EntryTransCosts variables).

3.4.2.4 Risk Constraints

Calculating the capital theoretically risked on the Target Date for a given Target Date volatility and risk-free interest rate is straightforward and is given by the following constraint:

Constraint Set 10: Risk constraint for each Prediction at Target Date

∀pεP:

$$∀ p ∈ P \text{:}$$

$${RiskBound}_{p}^{pred} = - ( \begin{matrix}{max}_{v ∈ {V}_{p}} ( \begin{matrix}{\sum }_{t ∈ {T}_{p}} - {payoff}_{t}^{leg} ( \begin{matrix}\begin{matrix}v , {TargetDate}_{p}^{pred} , \\ {TargetVol}_{p}^{pred} ,\end{matrix} \\ RFIntRate\end{matrix} ) \times \\ {LotSize}_{t}^{leg} \times {Quantity}_{t}^{leg}\end{matrix} ) + \\ \begin{matrix}{EntryNetCash}_{p}^{pred} + {EntryTransCosts}_{p}^{pred} + \\ {ExitTransCosts}_{p}^{pred} + {ExitSlippageCosts}_{p}^{pred}\end{matrix}\end{matrix} )$$

However, in cases the User may specify, throughout the entire period of the trade, the risked capital does not exceed the capital limit. This is to cover the eventuality of the User being forced to close a trade prematurely before the Target Date due to external factors. Moreover, for better system accuracy, the User may be asked to specify a range of volatilities and risk-free interest rates spanning the life of the trade.

Since option time value decays non-linearly, it is computationally complex to identify the worst case scenario precisely in these conditions—it may involve performing several calculations for every day in the trade.

According to an embodiment, the bounds on the amount of risked capital may be determined by performing calculations on the first (Entry) and last (Target) days of the trade. One having ordinary skill in the art will appreciate that there are several alternative approaches to generating bounds. An exemplary approach is presented below without loss of generality to the model as a whole:

3.4.2.4.1 Worst-Time Value Bounds Approach

3.4.2.4.1.1 American-Style Options

The constraints presented here utilize the following fact, which holds for American-style options. On the first day of the trade, for a given volatility, risk-free-interest-rate, and strike-price-to-security-price distance, the time value of any option is at its greatest value. Conversely, on the last day of the trade, for a given volatility, risk-free-interest-rate and strike-price-to-security-price distance, the time value of any American option is at its lowest value.

Therefore, it is possible to infer that American options which are sold-to-open are at their most expensive on Day 1 of the trade, while American options that are bought-to-open are at their lowest value on the Target Date.

In one embodiment, the Tradelegs Platform may utilize this fact by identifying the worst-case pay-off point for all contracts (Security contracts included) where all sold-to-open option payoff curves assume maximum volatility and worst-case risk-free interest rate and a Day 1 valuation, and all bought-to-open option pay-off curves assume minimum volatility and worst-case risk-free interest rate and a Target Date valuation. The Risked capital for a worst-case point constructed in this way will be an upper bound on the true Risked Capital throughout the trade.

For a long option “longoption”, which is traded from Date^{current} to TargetDate, and where within that period:
volatility ranges between MinVol and MaxVol,
risk-free interest rate ranges between MinRFRate and MaxRFRate,

and for any price value v of “longoption”'s underlying security, this may be represented conceptually as follows:

lowerpayoff(longoption,v)≦payoff(longoption,v,Date,Vol,RFRate)≦upperpayoff(longoption,v)

Where:

(option_type=call)→lowerpayoff(longoption,v)=payoff(longoption,v,TargetDate,MinVol,MinRFRate)

(option_type=put)→lowerpayoff(longoption,v)=payoff(longoption,v,TargetDate Minvol,MaxRFRate)

(option_type=call)→upperpayoff(longoption,v)=payoff(longoption,v,Date^{current},MaxVol,MaxRFRate)

(option_type=put)→upperpayoff(longoption,v)=payoff(longoption,v,Date^{current},MaxVol,MinRFRate)

Date^{current}≦Date≦TargetDate

MinVol≦Vol≦MaxVol

MinRFRate≦RFRate≦MaxRFRate

The constraints that capture this bound are described below:

Constraint Set 11: Risk Bound for each Prediction

∀pεP:

$$∀ p ∈ P \text{:}$$

$${RiskBound}_{p}^{pred} = - ( \begin{matrix}{max}_{v ∈ {V}_{p}} ( \begin{matrix}{\sum }_{t ∈ {T}_{p}} - {lowerpayoff}_{t}^{leg} ( v ) \times {LotSize}_{t }^{leg} \times \\ {Quantity}_{t}^{leg}\end{matrix} ) + \\ \begin{matrix}{EntryNetCash}_{p}^{pred} + {EntryTransCosts}_{p }^{pred} + \\ {ExitTransCosts}_{p}^{pred} + {ExitSlippageCosts}_{p}^{pred}\end{matrix}\end{matrix} )$$

Where lowerpayoffₜ^{leg}(v) is defined as:

∀pεP,∀tεTₚ,SecTypeₜ^{leg}=option,OrderTypeₜ^{leg}=buy-to-open,∀vεV_{P}:

(OptTypeₜ^{leg}=call)→lowerpayoffₜ^{leg}(v)=payoffₜ^{leg}(v,TargetDateₚ^{pred},MinVolₚ^{pred},MinRFRate)

(OptTypeₜ^{leg}=put)→lowerpayoffₜ^{leg}(v)=payoffₜ^{leg}(v,TargetDateₚ^{pred},MinVolₚ^{pred},MaxRFRate)

∀pεP,∀tεTₚ,SecTypeₜ^{leg}=option,OrderTypeₜ^{leg}=sell-to-open,∀vεVₚ:

(OptTypeₜ^{leg}=call)→lowerpayoffₜ^{leg}(v)=payoffₜ^{leg}(v,Date^{current},MaxVolₚ^{pred},MaxRFRate)

(OptTypeₜ^{leg}=put)→lowerpayoffₜ^{leg}(v)=payoffₜ^{leg}(v,Date^{current},MaxVolₚ^{pred},MinRFRate)

3.4.2.4.1.2 European-Style Options

Unlike American-Style options, European-Style options exhibit the following characteristic: for a given volatility, risk-free interest rate, strike-price-to-security-price distance, the time value of any option is not always at its greatest value at Day 1 valuation. This useful bounding property is actually violated for certain deep in-the-money options (most commonly deep in-the-money put options).

In one embodiment, to obtain more accurate bounds for European options, it is assumed that American-Style options are worth more than their corresponding European options. For European options that are “sold-to-open” (only), the payoff curve for each corresponding American-Style option is used to provide the necessary worst-case bound.

The system modifies the payoff curve computation algorithm appropriately (from European to American valuation in the relevant cases) to obtain these more accurate bounding values. The generated bound is accurate enough for our purposes.

3.4.2.4.1.3 Stock-based Securities

For stock-based securities lowerpayoffₜ^{leg} (v) can be assumed to be independent of the date, volatility and interest rate:

∀pεP,∀tεTₚ,SecTypeₜ^{leg}=security,OrderTypeₜ^{leg}=buy-to-open,∀vεVₚ.

lowerpayoffₜ^{leg}(v)=payoffₜ^{leg}(v, _, _, _)

Appropriate lowerpayoffₜ^{leg}(v) constraints can be defined for other security types, such as futures, commodities, etc.

Constraint Set 12: Risk Bound for each underlying Security

$$∀ s ∈ S \text{:} {RiskBound}_{s}^{se c} = {\sum }_{p ∈ P ⋀ Se {c}_{p}^{pred} = s} {RiskBound}_{p}^{pred}$$

The total risk bound is the sum of all the risk bound variables for each Security (see Constraint Set 13).

Constraint Set 13: Total Risk Bound

$${RiskBound}^{total} = {\sum }_{s ∈ S} {RiskBound}_{s}^{se c}$$

The following is one description of how this bound is used within the model. The maximum risk capital limit is an upper bound for the total risk bound:

Constraint Set 14: Maximum Risk Capital

RiskBound^{total}≦MaxCapRisk^{total}

3.4.2.5 Investment Constraints

Investment constraints limit the amount of capital that must be set aside by a User who wishes to execute the trade until its completion.

Constraint Set 15: Investment per Prediction

$$∀ p ∈ P \text{:}$$

$${Investment}_{p}^{pred} = max ( \begin{matrix}{RiskBound}_{p}^{pred} , - ( \begin{matrix}{EntryNetCash}_{p }^{pred} + \\ {EntryTransCosts}_{p}^{pred}\end{matrix} ) + \\ {ExitTransCosts}_{p}^{pred} + {ExitSlippageCosts}_{p}^{pred}\end{matrix} )$$

Constraint Set 16: Investment per Security

$$∀ s ∈ S \text{:} {Investment}_{s}^{se c} = {\sum }_{p ∈ P ⋀ S {ec}_{p}^{pred} = s} {Investment}_{p}^{pred}$$

Constraint Set 17: Total Investment

$${Investment}^{total} = {\sum }_{s ∈ S} {Investment}_{s}^{se c}$$

The total investment is limited using the maximum invested capital limit as follows:

Constraint Set 18: Invested Capital Constraint

Investment^{total}≦MaxCapInv^{total}

3.4.2.6 Maximum Number of Security Contracts Constraints

This section explains how the maximum number of security contracts constraint variants are modeled. In one embodiment, there are three variants of the constraint: the first applies globally to contracts; the second to contracts per Security; and the third to contracts per Prediction.

Constraint Set 19: Maximum Number of Security Contracts

$${\sum }_{t ∈ T : Se {cType}_{t}^{leg} = security} {Quantity}_{t}^{leg} \leq {MaxSecContr}^{total}$$

Constraint Set 20: Maximum No. of Security Contracts per Security

$$∀ s ∈ S \text{:} {\sum }_{t ∈ {T}_{s} : {SecType}_{t}^{leg} = security} {Quantity}_{t}^{leg} \leq {MaxSecContr}_{s}^{se c}$$

Constraint Set 21: Maximum No. of Security Contracts per Prediction

$$∀ p ∈ P \text{:} {\sum }_{t ∈ {T}_{p} : {SecType}_{t}^{leg} = security} {Quantity}_{t}^{leg} \leq {MaxSecContr}_{p}^{pred}$$

3.4.2.7 Maximum Number of Option Contracts Constraints

This section explains how the maximum number of option contracts constraint variants are modeled. There are three variants of the constraint: the first applies globally to contracts; the second to contracts per Security; and the third to contracts per Prediction. Constraint Set 22: Maximum Number of Option Contracts

$${\sum }_{t ∈ T : {SecType}_{t}^{leg} = option} {Quantity}_{t}^{leg} \leq {MaxOptContr}^{total}$$

Constraint Set 23: Maximum No. of Option Contracts per Security

$$∀ s ∈ S \text{:} {\sum }_{t ∈ {T}_{s} : {SecType}_{t}^{leg} = option} {Quantity}_{t}^{leg} \leq {MaxOptContr}_{s}^{se c}$$

Constraint Set 24: Maximum No. of Option Contracts per Prediction

$$∀ p ∈ P \text{:} {\sum }_{t ∈ {T}_{p} : {SecType}_{t}^{leg} = option} {Quantity}_{t}^{leg} \leq {MaxOptContr}_{p}^{pred}$$

3.4.2.8 Maximum Number of Legs

The maximum number of Trade Legs for a trade can be stated using the indicator variables as follows:

$${\sum }_{t ∈ T} {Bool}_{t}^{leg} \leq MaxLegs$$

Boolₜ^{leg} depends on the decision variables Quantityₜ^{leg}. The relationship between the variables is given below:

∀tεT:(Quantityₜ^{leg}>0) [symbol] (Boolₗ^{leg}=1)

∀tεT:(Quantityₜ^{leg}=0) [symbol] (Boolₜ^{leg}=0)

3.4.2.9 Position Diversification

3.4.2.9.1 Diversification per Security

∀sεS:

Investmentₛ^{sec}≦MaxCapInvₛ^{sec}

Riskboundₛ^{sec}≦MaxCapRisksₛ^{sec}

3.4.2.9.2 Diversification per Prediction

∀pεP:

Investmentₚ^{pred}≦MaxCapInvₚ^{pred}

RiskBoundₚ^{pred}≦MaxCapRiskPreₚ^{pred}

3.4.2.10 Return Constraints

Before defining the Return on Investment (ROI) and the Annualized ROI, the following terms are defined:
Return (Average Expected Return)
Annualized Return

Returns are additive, i.e. the total return is the sum of the return for each Security.

$${AvgExpReturn}^{total} = {\sum }_{s ∈ S} {AvgExpReturn}_{s}^{se c}$$

And similarly the returns for each Security are additive for the Trade Legs.

$$∀ s ∈ S \text{:} {AvgExpReturn}_{s}^{s e c} = {\sum }_{t ∈ {T}_{s}} {AvgExpReturn}_{t}^{leg}$$

Where the return for each Trade Leg is defined as:

∀tεT:

AvgExpReturnₜ^{leg}=Quantityₜ^{leg}×LotSizeₜ^{leg}×AvgExpPayoffₜ^{leg}+EntryNetCashₜ^{leg}+EntryTransCostsₜ^{leg}+ExitTransCostsₜ^{leg}+ExitSlippageCostsₜ^{leg}

Thus, the ROI constraint can be expressed as:

AvgExpReturn^{total}/Investment^{total}≧MinROI

In an embodiment, the annualized return is defined as follows, wherein the annualized returns are additive for the Securities:

$${AvgExpAnnualReturn}^{total} = {\sum }_{s ∈ S} {AvgExpAnnualReturn}_{s}^{se c}$$

And the annualized returns for each Security are additive for the Trade Legs:

$$∀ s ∈ S \text{:} {AvgExpAnnualReturn}_{s}^{se c} = {\sum }_{t ∈ {T}_{s}} {AvgExpAnnualReturn}_{t}^{leg}$$

Where the annualized return for a Trade Leg is defined as:

$$∀ t ∈ T \text{:} {AvgExpAnnualReturn}_{t}^{leg} = \frac{{Days}^{year}}{( {TargetDate}_{t}^{leg} - {Date}^{current} )} ( {AvgExpReturn}_{t}^{leg} )$$

Thus, the minimum annualized ROI is defined by the following constraint:

AvgExpAnnualReturn^{total}/Investment^{total}≧MinROI^{annual}

3.4.2.11 Minimum Profit/Risk Ratio

The terms profit and risk may be defined as:
The profit equals the (average expected) return defined in the previous section.
The risk equals the sum of the risk variables for all securities (RiskBound^{total})

Thus, the profit/loss ratio is expressed as follows:

AvgExpReturn^{total}/RiskBound^{total}≧MinPRRatio

Variants of the constraint can be applied per Security or per Prediction.

3.4.2.12 Minimum Expected Profitability

This may defined as:

AvgExpReturn^{total}≧MinExpProf

Variants of the constraint can be applied per Security or per Prediction.

3.4.3 Optimization Criteria

This section describes the optimization criteria and how they are modeled.

3.4.3.1 Maximize Average Expected Profit

The optimization goal is to maximize the expected profit. The corresponding maximization expression is given below:

$$maximize ( {\sum }_{t ∈ T} {Wt}_{t}^{leg} \times {AvgExpReturn}_{t}^{leg} )$$

Where Wtₜ^{leg} is the weight assigned to each Trade Leg inherited from its prediction's Confidence-Weight (∀tεT, p=Predₜ^{leg}:Wtₜ^{leg}=Wtₚ^{pred}).

3.4.3.2 Maximize Return On Investment (ROI)

The ROI maximization expression is given below:

maximize(AvgExpReturn^{total}/Investment^{total})

The Annualized ROI maximization expression is given below:

maximize(AvgExpAnnualReturn^{total}/Investment^{total})

3.4.3.3 Maximize Profit/Risk Ratio

The corresponding maximization expression is given below:

maximize(AvgExpReturn^{total}/RiskBound^{total})

The Tradelegs Platform may also include a mathematical solver 236 component. In one embodiment, a mixed integer solver may include a minimization or maximization of a linear function subject to constraints. The solver may incorporate a variety of techniques including the branch and bound technique, the branch and cut technique and/or the branch and price technique. The mixed integer solver may receive and/or transmit data to a variety of components including the domain model, the prediction, and the optimization component. In one embodiment, other components illustrated in FIG. 2 may also receive and transmit data to the mathematical solver.

3.5 Mathematical Solver

According to an embodiment, this section describes an example of how the model is adapted in order to be expressed in a form addressable by a mathematical solver. In this embodiment, we utilize a Mixed Integer Programming (MIP) representation, and show how a Mixed Integer Programming (MIP) solver can be used to optimize the non-linear model.

This solver class was selected due to its efficacy on CSOPs with many linear constraints such as the one described in this section. There are many commercial solver implementations for Mixed Integer Programming (otherwise known as Mixed Integer Linear Programming (MILP)), but one of the Simplex-based methods described in the above reference can be utilized.

3.5.1 Constants and Variables

The constants and variables of the MIP solver are the same as the ones described in the model. In this example, the variables that require additional work in order to be expressed in an MIP solver are discussed.

3.5.1.1 MIP Solver Integer Variable Declarations

| MIP Solver | | |
|---|---|---|
| Integer Variables | Description | Type |
| Quantityₜ^{leg}, t ε T | Target Date exit Quantity | Decision Variable |
| | for Trade Leg. Note that on | (Integer ≧ 0) |
| | initial trade entry, the | |
| | quantity is the same for | |
| | Trade Leg entry. | |
| Boolₜ^{leg}, t ε T | Indicates whether the Trade | Dependent Variable |
| | Leg is used or not | (Boolean) |
| HundredLotsₜ^{leg}, t ε T | Indicates quantity of Trade | Dependent Variable |
| | Legs in lots of 100 | (Integer ≧ 0) |
| | contracts | |
| EntryQty_{t,l}^{leg}, t ε T | Quantity for Trade Leg | Dependent Variable |
| | bought/sold at specific | (Integer ≧ 0) |
| | market level 1 at entry | |
| | (Open) | |
| ExitQty_{t,l}^{leg}, t ε T | Quantity for Trade Leg | Dependent Variable |
| | bought/sold at specific | (Integer ≧ 0) |
| | market level 1 at exit | |
| | (Close) | |

3.5.1.2 Indicator Variables

Indicator variables (Boolₜ^{leg}) are integer variables that depend on the values of integer variables Quantityₜ^{leg}.

∀tεT:(Quantityₜ^{leg}>0) [symbol] (Boolₜ^{leg}=1)

∀tεT:(Quantityₜ^{leg}0) [symbol] (Boolₜ^{leg}=0)

First, if Quantityₜ^{leg} is 0 then the corresponding indicator variable (Boolₜ^{leg} should be set to 0:

∀tεT:Quantityₜ^{leg}≧Boolₜ^{leg}

Next, if Quantityₜ^{leg} is greater than 0, then the corresponding indicator variable (Boolₜ^{leg}) should be set to 1:

∀tεT:Quantityₜ^{leg}≦M×Boolₜ^{leg}

where M is a known upper bound for Quantityₜ^{leg}

In the case of securities, M can be set to the Maximum Number of Security Contracts (MaxSecContr^{total}).

In the case of options, M can be set to the Maximum Number of Option Contracts (MaxOptContr^{total}).

3.5.2 Constraints

Most of the constraints specified in the model can be applied as is in a MIP solver. In this section, the constraints that typically require additional work are discussed.

3.5.2.1 Transaction Costs

The model specifies the following constraints for typical examples of lot-based transaction costs:

∀tεT(SecTypeₜ^{leg}=security)→(HundredLotsₜ^{leg}=┌Quantityₜ^{leg}/100┐)

∀tεT(SecTypeₜ^{leg}=option)→(Quantityₜ^{leg}=HundredLotsₜ^{leg})

Corresponding examples can be modeled in MIP as follows:

∀tεT(SecTypeₜ^{leg}=security)→(Quantityₜ^{leg}≦100×HundredLotsₜ^{leg})

∀tεT(SecTypeₜ^{leg}=option)→(Quantityₜ^{leg}=HundredLotsₜ^{leg})

3.5.2.2 Risk Constraints

The following risk constraint may be expressed in a linear constraint.

∀pεP:

$$∀ p ∈ P \text{:}$$

$${RiskBound}_{p}^{pred} = - ( \begin{matrix}\begin{matrix}{max}_{v ∈ {V}_{p}} ( \begin{matrix}{\sum }_{t ∈ {T}_{p}} - {lowerpayoff}_{t}^{leg} ( v ) \times \\ {LotSize}_{t}^{leg} \times {Quantity}_{t}^{leg}\end{matrix} ) + \\ {EntryNetCash}_{p}^{pred} +\end{matrix} \\ \begin{matrix}\begin{matrix}{EntryTransCosts}_{p}^{pred} + \\ {ExitTransCosts}_{p}^{pred} +\end{matrix} \\ {ExitSlippageCosts}_{p}^{pred}\end{matrix}\end{matrix} )$$

This is done by constraining the lower bound of the RiskBoundₚ^{pred} variable as follows:

∀pεP,∀vεVₚ:

$$∀ p ∈ P , ∀ v ∈ {V}_{P} \text{:}$$

$${RiskBound}_{p}^{pred} \geq - ( \begin{matrix}\begin{matrix}{EntryNetCash}_{p}^{pred} + \\ ( \begin{matrix}\begin{matrix}{EntryTransCosts}_{p}^{pred} + \\ {ExitTransCosts}_{p}^{pred} +\end{matrix} \\ {ExitSlippageCosts}_{p}^{pred}\end{matrix} ) +\end{matrix} \\ \begin{matrix}{\sum }_{t ∈ {T}_{p}} {lowerpayoff}_{t}^{leg} ( v ) \times \\ {LotSize}_{t}^{leg} \times {Quantity}_{t}^{leg}\end{matrix}\end{matrix} )$$

3.5.2.3 Minimum (Annualized) ROI

The model specifies the following constraints for minimum ROI and minimum annualized ROI:

AvgExpReturn^{total}/Investment^{total}≧MinROI

AvgExpAnnualReturn^{total}/Investment^{total}≧MinROI^{annual}

For the MIP solver, the above constraints can be stated as follows:

AvgExpReturn^{total}−MinROI×Investment^{total}≧0

AvgExpReturn^{total}−MinROI^{annual}×Investment^{total}≧0

3.5.2.4 Minimum Profit/Risk Ratio

The model specifies the following constraint:

AvgExpReturn^{total}−/Riskbound^{total}≧MinPRRatio

For the MIP solver the above constraint is stated as:

AvgExpReturn^{total}−MinPRRatio×RiskBound^{total}≧0

Variants of the constraint can be applied per Security or per Prediction.

3.5.3 Optimization Criteria
Maximize Average Expected Profit
Maximize Return On Investment (ROI)
Maximize Profit/Risk Ratio

The last two objectives are nonlinear and cannot be used as is in a Mixed Integer Programming (MIP) Solver. Instead, the MIP Solver can be used as a subroutine in a “dichotomic” search that determines whether the optimal solution is above or below a certain bound.

The following paragraphs describe the process:

Solve the problem using the MIP solver. After a solution is found, the criterion's range of values is split into two ranges (one upper, and one lower) by passing bounds to the MIP solver as constraints (minimum/maximum ROI or minimum/maximum Profit/Risk ratio).

Solve for the upper range by the addition of a criterion lower bound constraint. Repeat this step until there is no solution in the upper range. When it fails, solve for the last lower range.

Repeat the process until a solution is found within an acceptable maximum possible distance from the optimal.

The following pseudo code describes the process in more detail.

1. Function dichotomic_search (Min,Max,Delta)

| | |
|---|---|
| 2. | Solve using MIP Solver maximizing the following |
| | expression: (AvgExpReturn^{total} − RiskBound^{total}) |
| 3. | If MIP Solver is successful |

| | |
|---|---|
| 4. | ObjectiveValue = Get MIPSolver value for the |
| | following expression: (AvgExpReturn^{total} / RiskBound^{total}) |
| 5. | dichotomic_search_process |
| | (ObjectiveValue,false,Max,Delta) |

| | |
|---|---|
| 6. | Else |

| | |
|---|---|
| 7. | Report no solution for range Min..Max |

| | |
|---|---|
| 8. | End |

```
  9. End
  1. Function
  dichotomic_search_process(Min,MaxSolutionFound,Max,Delta)
```

| | |
|---|---|
| 2. | Gap = Max − Min |
| 3. | If (Gap ≦ Delta and MaxSolutionFound) |

| | |
|---|---|
| 4. | Report solution found for Max and Exit |

| | |
|---|---|
| 5. | Elsif (Gap < Delta) |

| | |
|---|---|
| 6. | Report solution found for Min and Exit |

| | |
|---|---|
| 7. | Else |

| | |
|---|---|
| 8. | Split = Min + Gap * 0.5 |
| 9. | Assert (Split x RiskBound^{total} ≦AvgExpReturn≦ Max) |
| 10. | Solve using MIP Solver maximizing the following |
| | expression (AvgExpReturn^{total} − RiskBound^{total}) |
| 11. | If MIP Solver is successful |

| | |
|---|---|
| 12. | ObjectiveValue = Get MIPSolver value for the |
| | following expression (AvgExpReturn^{total} / |
| | RiskBound^{total}) |
| 13. | dichotomic_search_process(ObjectiveValue, |
| | MaxSolutionFound, Max, Delta) |

| | |
|---|---|
| 14. | Else |

| | |
|---|---|
| 15. | Retract constraint of line 9 |
| 16. | Report failure for range Split..Max |
| 17. | dichotomic_search_process(Min,false,Split,Delta) |

| | |
|---|---|
| 18. | End |

| | |
|---|---|
| 19. | End |

20. End

### Exemplary Graphical User Interface (GUI) and Reporting Methodology

The Tradelegs Platform may also include a user interface 238 component. In one embodiment, the user interface may include a graphical user interface, a virtual user interface, a txt based (command line interface) and/or the like. The Tradelegs Platform may advantageously allow for hybrid customization of the user interface. For example, a user of the Tradelegs Platform may desire a specific user interface for a desktop environment which may include multiple monitors. The Tradelegs Platform may allow for the specification of a different user interface for a tablet environment and/or mobile device environment. This section describes innovations that relate to how the system interacts with the User. Subsection 4.1 focuses on how the User can input a scenario of predictions. Subsection 4.2 focuses on reporting the optimization results back to the User.

4.1 Scenario Input

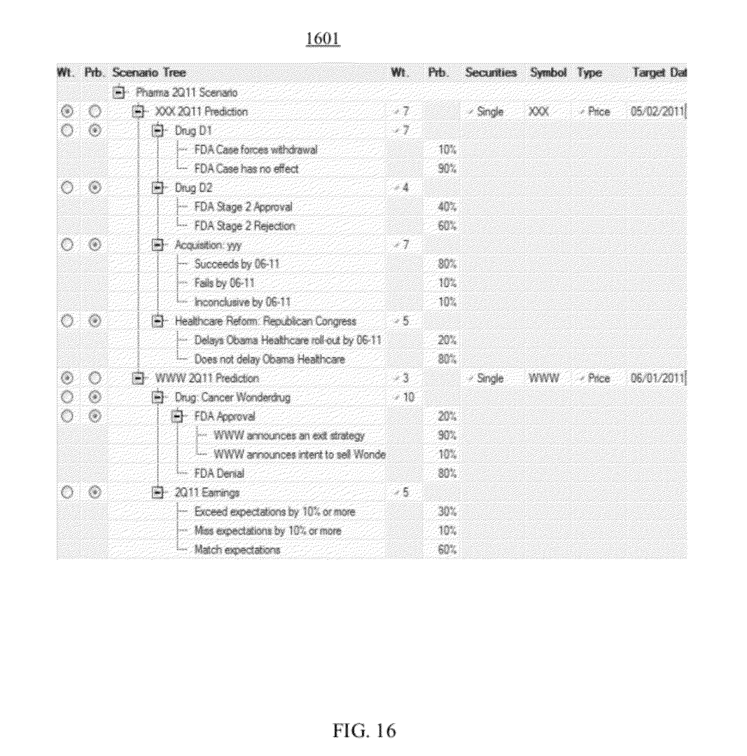

This subsection describes the following Scenario Input innovation areas:
A Tree-Grid is a GUI interface comprising two panels. On the Left-Hand-Side, a tree panel is used to populate a hierarchical tree. On the Right-Hand-Side, a table panel is used to populate a set of values (one per labeled column) for every entry (row) in the tree. FIG. 16 illustrates an embodiment of a Tree-Grid 1601 to represent the hierarchy of Predictions, Outcome groups and Outcomes;
the various ways the system helps the User to generate Outcome Performance Prediction Curves;
and how the system generates a Consolidated Performance Prediction Curve for each prediction.

4.1.1 Scenario Editor Tree-Grid

In the Scenario Editor, a Tree-Grid may represent the hierarchy of Predictions, Outcome Groups and Outcomes within the Scenario. In this Tree-Grid, the root (first level) node is the Scenario; the Predictions are the second level nodes; and the nodes at all other levels are Outcome groups or Outcomes. Outcome Groups can contain Outcomes or Outcome groups (which enables Outcome Groups to be nested), but Outcomes may be leaf nodes of the Outcome-Tree (i.e. there are no nodes under Outcomes).

In any node, apart from the root Scenario node, the User can choose the weighting method used for its children nodes (Impact-Weight or Probability). For the Scenario node, whose children may be Predictions, the User may enter Confidence-Weights or accept the default (equal-across-predictions) Confidence-Weights supplied by the system.

Each Scenario may contain a number of predictions, each with a Security (or a Security Basket) and a Target Date.

However, Price-Performance Predictions for the same Security (or Security Basket) may have different Target Dates. The User may otherwise enter any combination of Securities and Target Dates.

For Relative-Performance Predictions, Predictions for the same Security (or Security Basket) and the same Baseline Security or Baseline Basket, also may have different Target Dates.

### Scenario Example

As illustrated in FIG. 16, the Scenario has two Predictions, one for company XXX and one for company WWW. For company XXX, there are 4 outcome groups each containing a set of outcomes.

For company WWW, there are two Outcome Groups: “Drug: Cancer Wonderdrug” and “2Q11 Earnings”. The former has, nested within it, the Outcome Group “FDA Approval”, which itself includes 2 Outcomes.

The example also shows that each of the Predictions is associated with a Confidence-Weight (7 and 3), while the Outcome Groups (and Outcomes) may be associated with Impact-Weights or probabilities as needed, provided the children of the same parent apply the same weighting method.

4.1.2 Outcome Input

For each Outcome in the tree, an Outcome Performance Prediction Curve may be generated by the User. This section describes how the User can generate such curves via the graphical user interface (GUI).

4.1.2.1 Multiple Range Method

One method for generating Outcome Performance Prediction Curves is the Multiple Range Method.

In this method, several performance ranges, each bounded by its own minimum and maximum performance bound, are associated with a probability that the Security or Security Basket's performance lies within them at the Target Date.

For example, the probability of a Security lying within the range $20.$30 may be 68%, while the probability of its lying within the range $15.$50 may be 95%. In a Relative Performance context, it could be stated that the Security's performance, relative to the S&P500 index, is expected to be −5%.+15% with a 68% probability and −15%.+60% with a 95% probability.

By entering several such ranges for each outcome, Outcome Performance Prediction Curves may be generated for each Outcome in the tree.

The following is an example using an exemplary implementation and further includes a more generalized description.

4.1.2.1.1 Example implementation

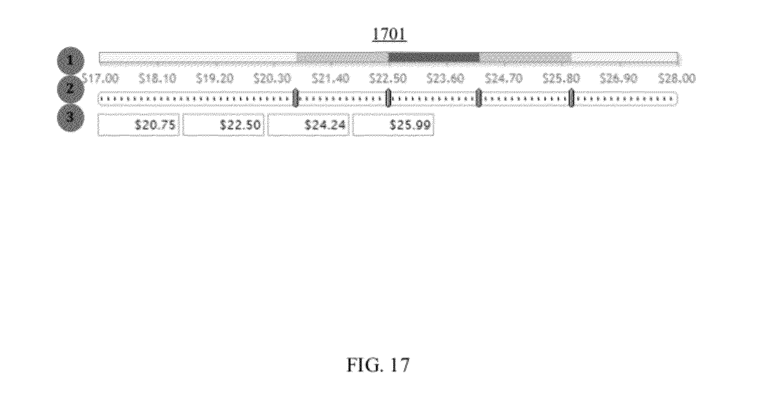

FIG. 17 shows the outcome specific parameters 1701 for generating an Outcome Price Performance Prediction Curve. There are 3 parts to the screenshot:

1. The outcome ranges as a bar chart

2. Sliders for defining performance ranges

3. Input text boxes for the ranges

In this particular example, three performance ranges are used.

The probabilities of each range occurring are fixed by the system up-front for each range, as shown in the following exemplary table. The lower two probabilities were inspired by the probabilities of a value occurring within 1 and 2 standard deviations away from the mean of a random value of a statistical normal distribution, but are in fact arbitrary and could be replaced by alternative values as desired.

| | |
|---|---|
| First Range | 100% |
| Second Range | 95.44% |
| Third Range | 68.26% |

The User may then specify the performance range bounds for each range while understanding they are associated with the above probabilities of being met.
The first Range is a “zero-risk range” (100% probability of the price lying between the two values). This is defined by the prediction's Minimum and Maximum performance extreme values entered by the User for the Prediction. In this example it is defined by the two extreme values in the bar chart ($17, $28).
The second range is a “medium-risk range” (95.44% probability), defined using the leftmost and rightmost sliders (or the corresponding input text boxes). It is currently set to ($20.75, $25.99).
The third range is a “higher-risk range” (68.26% probability), defined by the two innermost sliders (or the two innermost input text boxes). It is currently set to ($22.50, $24.24).

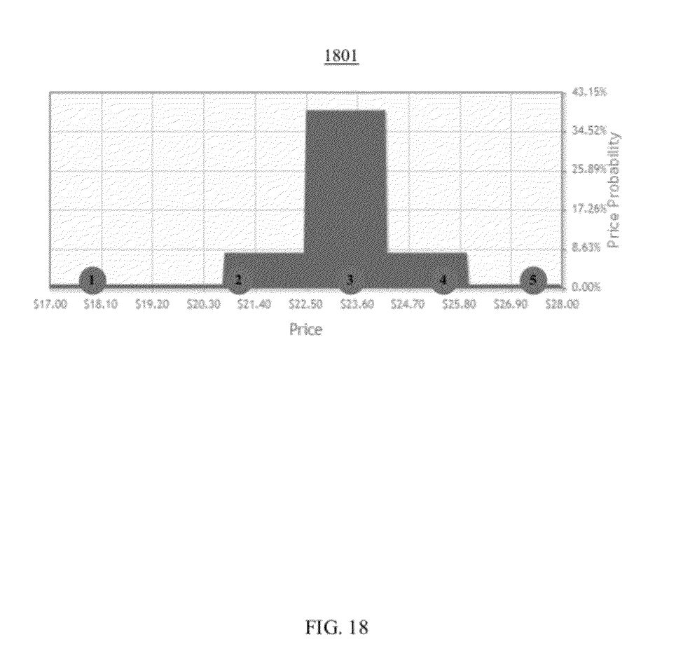

This generates the Outcome Price-Performance Prediction Curve 1801 illustrated in FIG. 18.

The system assumes a uniform probability distribution for each of the 5 areas. Note that the probability levels are the same for areas 2 and 4, and are the same for areas 1 and 5.

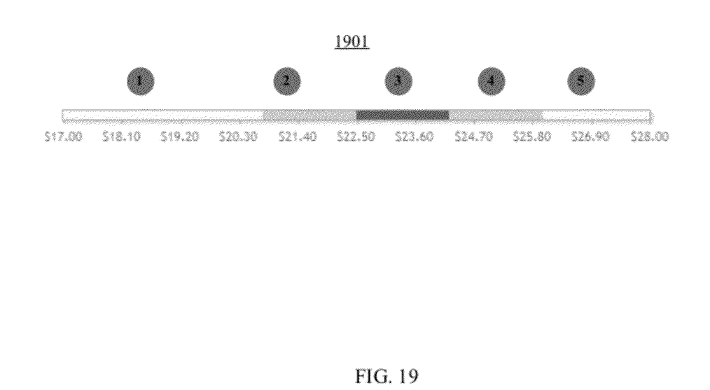

FIG. 19 illustrates how the three ranges become 5 areas in the slider 1901.

4.1.2.1.2 Generalized Multiple Range Method

In one embodiment, the User provides 3 performance ranges. The first range is the Prediction Performance Range which limits all outcomes for that prediction. The second and third ranges are specific to the outcome.

This may be generalized to arbitrary ranges and probabilities. In the generalized case, the User provides an arbitrary number of performance ranges each associated with a probability percentage. Each range is contained within the previous range and the probability percentage that corresponds to each range decreases as the range size reduces. The first range is always the Prediction Performance Range which limits all outcomes for the prediction.

4.1.2.1.3 Smoothing for Multiple Range Methods

The graph figures may generate step-functions if a uniform distribution is assumed for the different range areas. However, smoothing algorithms could be applied to smooth the curves (iterative, moving or exponential average interpolation). If any smoothing methods are used, the area under the curve may be restored to 1. This may be achieved by multiplying the piecewise linear curve by 1/(current area under curve).

4.1.2.2 Other Outcome Performance Prediction Curve Input Methods

4.1.2.2.1 Statistical Probability Distributions

Other methods for generating Outcome Performance Prediction Curves may be based on known probability distributions, e.g.:
Normal distribution
Lognormal distribution
Extreme Value distributions
Power Law distributions

The User may set various parameters to control the shape of the performance curve (e.g. the mean, standard deviation size for a normal distribution).

In one embodiment, the Tradelegs Platform may provide sliders and/or entry fields that correspond to actual values (prices or percentages).

For example, the User can define a distribution using a slider for the predicted mean, and a slider for the predicted standard deviation, a slider for kurtosis, skewness, etc., with the ability to also optionally input these numbers manually in input fields.

4.1.2.2.2 General Probability Curve Editor

Another, more flexible way of generating Outcome Performance Prediction Curves is by using a curve that can be edited interactively. The User can add/remove points, as well as drag existing points of the probability curve manually to construct a customized probability curve for the Security's performance when a certain outcome occurs by the Target Date.

In this case, care must be taken to normalize the curve so that the area under the curve is equal to 1. This can be achieved by multiplying the resulting piecewise linear curve by 1/(current area under curve).

4.1.2.3 Prediction Input

A Confidence-Weight can be associated with each prediction to reflect the confidence of the User in each prediction relative to other predictions in the scenario. This is taken into account by the optimizer as described in Section 3.4.3.1.

For each prediction, the system generates a Consolidated Performance Prediction Curve. This is done by adding the Outcome Performance Prediction Curves together after weighting them by their Aggregate Weighted-Probability—the algorithm generates the Aggregate Weighted-Probability from the Impact-Weights and Probabilities as follows:

1. Function compute_aggregate_probabilities_for_scenario(Scenario)

| | |
|---|---|
| 2. | For each Prediction in the Scenario |

| | |
|---|---|
| 3. | compute_aggregate_probabilities(Prediction node, 1) |

| | |
|---|---|
| 4. | End |

```
  5. End
  1. Function compute_aggregate_probabilities(Node,
  AggregateProbability)
```

| | |
|---|---|
| 2. | ChildNodes = children(Node) |
| 3. | If ImpactWeight is used for ChildNodes |

| | |
|---|---|
| 4. | Total = the sum of weights of all ChildNodes |

| | |
|---|---|
| 5. | End |
| 6. | For each ChildNode in ChildNodes |

| | |
|---|---|
| 7. | If ImpactWeight is used for ChildNode |

| | |
|---|---|
| 8. | ChildNodeAggregateProbability = |

(AggregateProbability) * (weight(ChildNode) /
Total)

| | |
|---|---|
| 9. | Else |
| 10. | ChildNodeAggregateProbability = |

(AggregateProbability) * (probability(ChildNode))

| | |
|---|---|
| 11. | End |
| 12. | compute_aggregate_probabilities(ChildNode, |
| | ChildNodeAggregateProbability) |
| 13. | End |

14. End

4.2 Output Reports

4.2.1 Prediction Profit/Loss Probability Curve

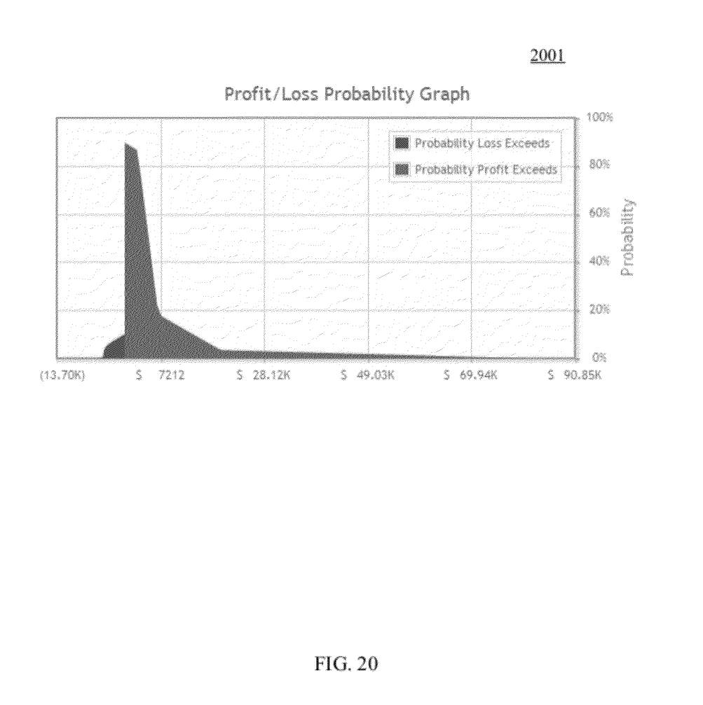

FIG. 20 illustrates an example of this curve. The Prediction Profit/Loss Probability Curve shows on the y-axis the cumulative probability of making a profit of at least X amount, where X is a positive value on the X-axis. It also shows on the y-axis the cumulative probability of loss of at most X amount, where X is a negative value on the X-axis. The probability is based on the prediction Consolidated Performance Prediction Curve.

This section describes how to generate the profit/loss probability curve for a prediction given a profit/loss curve for that prediction (described below).

There are two parts:

1. Generate a piecewise linear curve showing the cumulative distribution for profit (being greater than a value) ranging between [0.0, Prediction-Specific Best-Case Profit/Loss]

2. Generate a piecewise linear curve showing the cumulative distribution for loss (being less or equal to a value) ranging between [Prediction-Specific Worst-Case Profit/Loss, 0.0]

The following describes how to generate a piecewise linear curve that represents the cumulative distribution for profit (being greater than a value).

For part (1), the following function is called:

cumulative_distribution(0.0, Prediction-Specific Best-Case Profit/Loss, NoOfPoints, profit)

For part (2), the following function is called:

cumulative_distribution(Prediction-Specific Worst-Case Profit/Loss, 0.0, NoOfPoints, loss)

where NoOfPoints is a system constant.

Exemplary pseudo code for the cumulative distribution function is given below.

| | |
|---|---|
| 1. | Function cumulative_distribution(Min, Max, NoOfPoints ≧ 2, |
| | ProfitOrLoss) |

| | |
|---|---|
| 2. | V = Min |
| 3. | Create an empty piecewise linear curve structure C |
| 4. | While V ≦ Max |

| | |
|---|---|
| 5. | If ProfitOrLoss == profit |

| | |
|---|---|
| 6. | Compute S = the set of all (p1,p2) price intervals of |
| | the profit/loss curve where the corresponding |
| | profit/loss Y values > V |

| | |
|---|---|
| 7. | Else |

| | |
|---|---|
| 8. | Compute S = the set of all (p1,p2) price intervals of |
| | the profit/loss curve where the corresponding |
| | profit/loss Y values ≦ V |

| | |
|---|---|
| 9. | End |
| 10. | Set Prob = Sum of the areas under the Consolidated |
| | Performance Prediction |

Curve for the specified intervals in S (integration)

| | |
|---|---|
| 11. | Add point (V, Prob) to curve C |
| 12. | Increment V by (Max-Min)/NoOfPoints |

| | |
|---|---|
| 13. | End |
| 14. | Return C |

| | |
|---|---|
| 15. | End |

The Tradelegs Platform may further include a plurality of feature sets 240. For example, the Tradelegs Platform may include a position analysis feature set, a position maintenance feature set, a security basket feature set. These feature sets provide additional flexibility with respect to tailoring a specific optimization. In one embodiment, one or more features sets may communicate with the one or more components illustrated in FIG. 2.

5.1 Position Analysis

5.1.1 Purpose of the Feature-Set

The Tradelegs Optimization Method and System's optimization algorithm described in Section 3 is intended for use by an experienced User who is using it to guide trade entry.

By contrast, Position Analysis caters to two different cases. These are when the User wishes to:

1. assess a proposed trade that was generated by alternative means (such as by the User manually); or

2. to assess the quality of an existing trade that is currently in play.

Position Analysis is particularly useful when the User wishes to compare the trades generated by the Tradelegs Optimization Method and System with alternative trades generated without the support of the system, either:
to clarify the value of the Tradelegs Optimization Method and System and its proposed trades; or
to understand why an alternative trade the User has in mind was not recommended by the system (for instance, it may violate some constraints, or may not satisfy the objectives quite as efficiently, but these violations and inefficiencies may not be immediately clear to the User).

Existing trade analysis involves the analysis of currently open positions, and is useful when the User analyzes an existing open trade generated by alternative means (e.g. by the User, or by a different trading team), or when the trade originally proposed by the Tradelegs Optimization Method and System is not executed as per system recommendations, causing a divergence between the originally recommended and the open trade.

In both types of situation, the User will need to understand whether the existing trade satisfies all the trading constraints, and the potential profitability of the trade as well as the risk capital and invested capital associated with it.

5.1.2 Implementation

The Tradelegs Optimization Method and System Position Analysis functionality caters to the aforementioned use cases. Each constraint referred to in Section 3 is systematically checked for violation. This section describes how.

As described in Section 3.4.1, a Constraint Satisfaction and Optimization Problem (CSOP) is defined by
A set of variables (and constants)
A set of constraints
An optimization function

The objective of a Constraint Satisfaction and Optimization Solver is to find a solution to the CSOP problem that maximizes or minimizes the optimization function while satisfying the set of constraints.

In the case of Position Analysis, a variant of the CSOP is applied: the CSOP Checking Problem.

The CSOP Checking Problem utilizes exactly the same model variables, constraints and optimization function as its underlying CSOP: It comprises:

(1) An underlying CSOP (comprising a set of variables; a set of constraints; and an optimization function)

(2) an assignment A of all the CSOP variables to a set of corresponding values

The objective of a CSOP Checking problem is to generate:

1. The Violation-List comprising the list of constraints that are violated by the assignment A, if there are any CSOP constraint violations; or

2. The Objective-Value of the CSOP optimization function, which is defined to be the value that is returned by the CSOP optimization function after applying the assignment A to the CSOP's variables, if there are no CSOP constraint violations (i.e. no CSOP constraints are violated by the assignment A).

By mapping the user-input trade to appropriate values for variables Quantityₜ^{leg}, EntryQty_{t,l}^{leg}, ExitQty_{t,l}^{leg}, HundredLotsₜ^{leg} and Boolₜ^{leg} of thew model described in Section 3, the system identifies the violated constraints, or, if none exist, the value of the selected optimization criterion associated with the trade.

In this way, the system communicates the constraints that were found to be violated, if any, in human-readable form, and also generates appropriate graphs and reporting values for the analyzed trade.

P/L and optimization function reporting calculations correspond with those described for that section also. Reports also utilize the graphical and reporting innovations described in the GUI and reporting section for the Tradelegs Optimization Method and System optimization use case.

5.2 Position Maintenance

5.2.1 Purpose of the Feature-Set

Position Maintenance is a variant of the basic optimization and Position Analysis use cases. In Position Maintenance, the core Tradelegs Optimization Method and System optimization algorithm is extended to accept, as part of its inputs, all the previously closed and open trading legs in the life of a trade undergoing re-optimization.

This allows the Tradelegs Optimization Method and System optimization algorithm to observe all the constraints and objectives outlined in the optimization section, while taking into account the impact of previously closed positions on the overall trade's Profit/Loss, Risk Capital and Invested Capital.

Additionally, the cost and benefit of closing currently open positions is automatically evaluated by the algorithm, once it is modified to correctly account for the transaction and slippage costs of closing already-opened positions (it is always cheaper to close an existing position before opening a reverse position).

Note that with appropriate adjustments, Position Maintenance runs may thus yield multiple benefits:
The ability of the User to adjust his or her Predictions, as Outcomes get further clarified or are overtaken by events, thereby using the algorithm to re-optimize the trade within and across Predictions in a Scenario to take into account the latest Outcome-impacting information and the evolving User predictions.
The ability to readjust a Trading position within and across Predictions in a Scenario to capitalize on recent attractive market-price fluctuations.
The ability to modify capital for the current position by modifying the capitalization parameters, for example to lock-in existing profits or risked/invested capital. For example, a profitable prediction trade, or individual Trade Leg, that has achieved most of its targets with negligible residual benefit and open risk may be closed, freeing up its capital.
The ability to pyramid already realized profit to capitalize further a trade, aggressively reinvesting the additional capital obtained for maximum benefit, within the same Prediction or crossing over to other Predictions in the Scenario.

5.2.2 Implementation

As an optimization preprocessing step, the risk and invested capital amounts are adjusted to take into account previously closed trades. Open positions are represented within the optimization algorithm, and are accounted for by the algorithm by appropriately adjusting the cost and slippage accounting. Where a contract position is reversed in the optimization, the algorithm will seek to reduce transaction costs, and therefore automatically closes existing positions before opening new positions in the opposite direction. Otherwise the algorithm executes as expected. Reporting is extended to report on realized profits/losses as well as the status of the overall trade.

5.3 Security Baskets

5.3.1 Purpose of the Feature-Set

In some cases the User wishes to make a Price-Performance or a Relative-Performance prediction on a Security Basket: i.e. the User would like to trade a prediction on the performance of a group of securities as a whole, rather than the performance of a specific security, which may be subject to greater performance and liquidity risks from the User's standpoint.

5.3.2 Implementation

An artificial aggregated security is constructed with an artificial security price. For example, this may be accomplished by taking the sum of the market capitalization of all the involved securities, and dividing that by the number of their shares to obtain an aggregate Security Basket price. Many other basket security and index generating schemes exist, such as price-weighting, and could have been implemented instead. The User may then make Price-Performance and Relative-Performance predictions as described in Section 4.1 for this artificial security. The algorithm allocates invested and risked capital either equally across the securities and their options chains, or weighted by their current market capitalization.

5.4 Price-Performance Predictions

Although the embodiments of the Tradelegs Optimization System and Method described above include the application of a Mixed Integer Programming (MIP)-based implementation for Price-Performance predictions, one having skill in the art will appreciate that as the feature set and data sizes increase, alternative algorithms may be implemented.

The Tradelegs Platform may further include piecewise linear components 242. In one embodiment, a piecewise linear function may include a set of slopes, a set of slope breakpoints and a function value at a given point. The piecewise linear component may be used by the domain model or the performance prediction curve component or any other component to represent and perform operations on curves in order to generate new ones.

The Tradelegs Platform may further include a market data component 244.

6.1 Market Data Component

The Market Data Component is the component of the Tradelegs Platform for receiving and processing historic, delayed and/or real-time data for security and derivative contracts and their trading costs and other trade-related market data, such as stock events (dividends, splits, IPOs), market trading costs, and any other information. For example, the Tradelegs Platform may include a market price poller, a streaming market price processor, a historic data processor and storage, without limitation to these examples. In one embodiment, the Market Data component may receive and/or transmit data to any of the Tradelegs Platform components illustrated in FIG. 2 or the external market information source 106 and the user computer(s) 104 and the user interface 105 in FIG. 1.

Piecewise Linear Curves

The payoff curves are expressed as contiguous piecewise linear curves. Each curve consists of an ordered list of points (X,Y) such that each consecutive pair of points in the list defines a linear segment in the contiguous curve.

There are a number of operations on piecewise linear curves that are used in the pre-processing and post-processing of optimization data:
Adding two piecewise linear curves
Multiplying two piecewise linear curves
Adding an offset to a piecewise linear curve: this has the effect of moving the curve up or down with respect to the y-axis (adding or removing profit or loss for payoff curves)
Multiplying a piecewise linear curve by a factor
Determining the area under a piecewise linear curve

A.1 Adding or Multiplying Two Curves

In an embodiment, if it is assumed that the two piecewise linear curves have the same x values, then addition and multiplication can be implemented as follows:

1. Iterate over x values that are referred to in either curve, in
ascending order

| | |
|---|---|
| 2. | Find the y value for the first curve corresponding to the x |

value

| | |
|---|---|
| 3. | Find the y value for the second curve corresponding to the |

x value

| | |
|---|---|
| 4. | Add (or Multiply) the two y-values |
| 5. | Create a new output point (x, youtput), where youtput = the |

sum (or product) of the y-values)

Note: y-values for x-values not explicitly represented in a piecewise linear curve's list are generated by interpolating their values between the nearest point before x, and the nearest point after x.

For multiplication, it is also necessary to introduce additional points to the curves for correctness and precision. These can be introduced by specifying a maximum allowed x-interval value to ensure that the x value difference between two points will never be larger than this value.

A.2 Adding an Offset to a Curve

Note that the payoff curve does not include the entry net cash, transaction costs, or exit slippage. These variable costs are handled differently in the optimization, but for reporting purposes, after they have been fixed, these costs can be added to the payoff curve by adding an offset to construct an easy-to-visualize all-inclusive profit/loss curve.

| | |
|---|---|
| 1. | Iterate over points of curve |

| | |
|---|---|
| 2. | Create a new output point (x value, y-value + offset) |

A.3 Multiplying by a Factor

Also, note that the payoff curve is for a single contract (i.e. 1 security or 1 option exercise right). In order to construct a profit/loss curve that describes the profit loss impact of a larger quantity of this contract, it is necessary to multiply the payoff curve with the quantity and any other required multipliers (for 100-lot options the default multiplier is 100) before adding any other costs.

| | |
|---|---|
| 1. | Iterate over points of curve |

| | |
|---|---|
| 2. | Create a new output point (x value, y-value * factor) |

A.4 Determining the Area Under the Piecewise-Linear Curve

The following goes through all the points in the curve and adds the trapezoid area defined by the two points to the area. In effect, it implements the trapezium rule technique for calculating the integral of the curve.

| | |
|---|---|
| 1. | Area = 0 |
| 2. | Iterate over points of curve |

| | |
|---|---|
| 3. | Area += ((NextPoint.x − Point.x) * (NextPoint.y + |

Point.y))/2

Report Curves and Statistics

B.1 Prediction Profit/Loss Curve

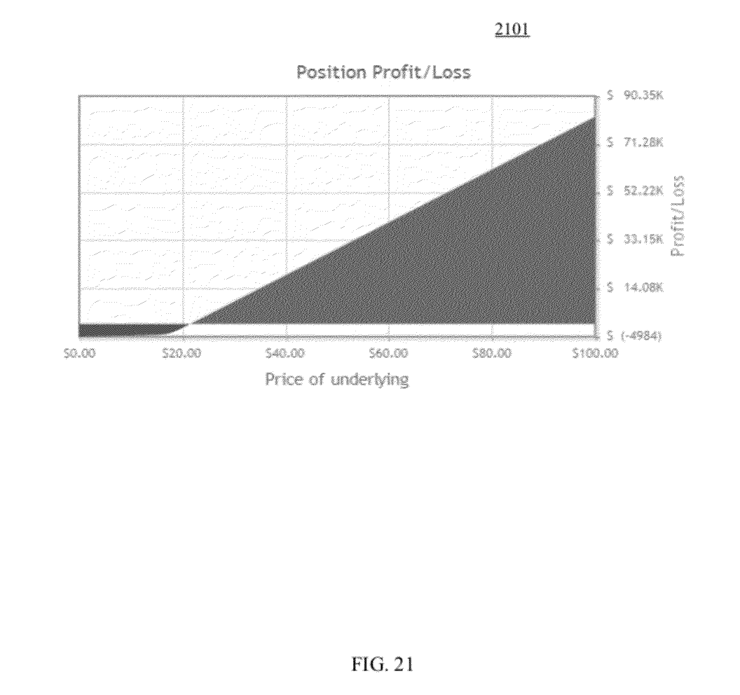

FIG. 21 illustrates the Prediction Profit/Loss Curve 2101. The Prediction Profit/Loss Curve shows on the y-axis the profit/loss that corresponds to the underlying asset price (on the x-axis) for a given set of Trade Legs. This allows the User to determine where the particular trade for the prediction becomes profitable.

This section describes how the profit/loss curve is constructed for a prediction given a set of Trade Legs. The Trade Legs are either provided by the optimizer or the User. In one embodiment, executed Trade Legs may be ignored.

Prediction Profit/Loss Curve Example

For each Trade Leg belonging to the prediction a profit/loss piecewise linear curve is constructed. Then those curves are added together to produce the prediction profit/loss piecewise linear curve.

The following shows how to construct a profit/loss piecewise linear curve for a single Trade Leg:

There are 5 components:

1. EntryNetCashₜ^{leg}: The entry net cash paid/received on entry (ignoring trading costs and fees) (negative value if paid/positive otherwise)

2. EntryTransCostsₜ^{leg}: The trading costs and fees on entry (negative value)

3. payoffₜ^{leg}(v, Date,Vol,RFRate): Amount paid/received on exit (ignoring trading costs and fees, and ignoring any slippage) (piecewise linear curve)

4. ExitTransCostsₜ^{leg}: The trading costs and fees on exit (negative value)

5. ExitSlippageCostsₜ^{leg}: Slippage costs on exit (negative value)

The amount paid/received on exit is a piecewise linear curve, where the amount (y-axis) varies according to the underlying asset price (x-axis).

In order to get the profit/loss curve, an offset to the piecewise linear curve defined by payoffₜ^{leg}(v,Date,Vol,RFRate): is computed as follows:

Offsetₜ^{leg}=EntryNetCashₜ^{leg}+EntryTransCostsₜ^{leg}+ExitTransCostsₜ^{leg}+ExitSlippageCostsₜ^{leg}

The resulting curve is the profit/loss curve.

∀tεT,∀vεV_{pred}_{ₜ}_{leg}:plcurveₜ^{leg}(v)=payoffₜ^{leg}(v,Date,Vol,RFRate)+Offsetₜ^{leg}

B.1.1 Prediction-Specific Position Worst-Case Profit/Loss

Once the profit/loss curve is constructed, the worst-case profit/loss for a prediction is the minimum y-value of the piecewise linear curve. The corresponding x-value is the underlying asset price for the worst-case profit/loss.

B.1.2 Prediction-Specific Position Best-Case Profit/Loss

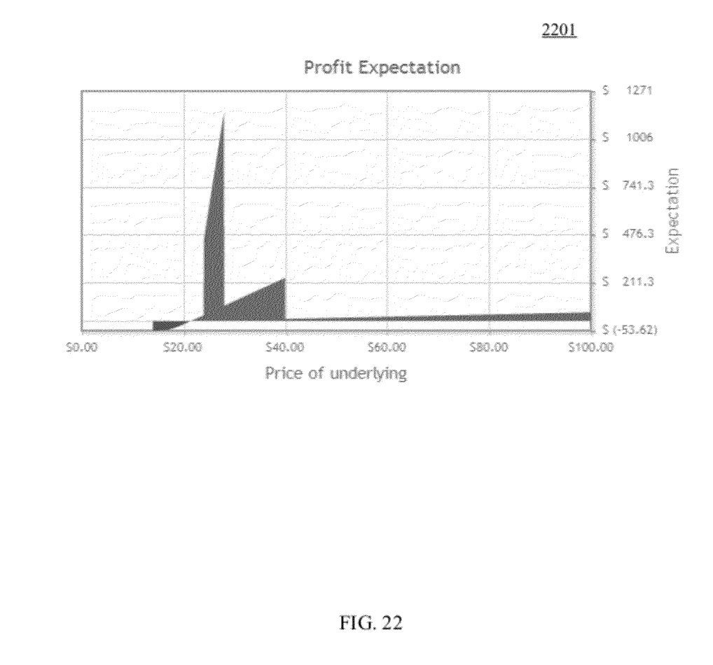

FIG. 22 illustrates a profit expectation graph 2201. Once the profit/loss curve is constructed, the best-case profit/loss for a prediction is the maximum y-value of the piecewise linear curve. The corresponding x-value is the underlying asset price for the best-case profit/loss.

B.2 Prediction Profit/Loss Expectation Curve

The Profit/Loss Expectation Curve shows the expected profit/loss on the y-axis with respect to the underlying asset price on the x-axis.

The following describes how to generate the Profit/Loss Expectation Curve.

The Profit/Loss Expectation Curve for a prediction is generated by multiplying the Prediction Profit/Loss (piecewise linear) curve (described above) with the Prediction Consolidated Performance (piecewise linear) curve (described in Section 4.2.1). Multiplying two piecewise linear curves together is described above.

Constraint Set 4: Rule Based Entry Costs

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps.

It will be appreciated that the above processes, and steps thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. It will further be appreciated that the process may be realized as computer executable code created using a structured programming language such as C, an object oriented programming language such as Java, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure.

What is claimed is:

1. A computer-implemented method, comprising:
receiving a plurality of optimization inputs relating to a security, the optimization inputs comprising a consolidated performance prediction curve representing a user's consolidated view of a probability associated with each of a plurality of different future performance levels associated with the security at a user-specified time; a set of financial constraints, market information, and an optimization objective;
determining, by a platform executable by a processor, an optimized financial trade position based on the plurality of optimization inputs; and
presenting, by the platform via a user interface of a computer, the optimized financial trade position to the user.

2. The computer-implemented method of claim 1, wherein the consolidated performance prediction curve comprises a consolidated price performance prediction curve comprising a probability distribution function or a comparable instrument representing the user's view of a probability-of-occurrence associated with each of a plurality of potential market prices of the security at the user-specified time.

3. The computer-implemented method of claim 1, wherein the consolidated performance prediction curve comprises a consolidated relative performance prediction curve comprising a probability distribution function or a comparable instrument representing the user's view of a probability-of-occurrence associated with each of a plurality of potential relative performance values of the security at the user-specified time, measured relative to a user-specified baseline security or a user-specified baseline security basket.

4. The computer-implemented method of claim 1, wherein the market information comprises at least one of one or more past or present market pricing values or trading costs relating to at least one of the security or a derivative.

5. The computer-implemented method of claim 1, wherein the optimization inputs further comprise one or more derivative pricing model parameters used to predict a plurality of future prices for the derivative in potential future situations.

6. The computer-implemented method of claim 1, wherein the set of financial constraints are user-inputted and comprise at least one of a capital constraint, a cash constraint, a trade position lifetime risk constraint, a return on investment (ROI) constraint, an initial margin constraint, a maintenance margin constraint, or a constraint limiting a derivative sensitivity analysis value.

7. The computer-implemented method of claim 6, wherein the constraint limiting the derivative sensitivity analysis value comprises at least one of a delta value, a theta value, a gamma value, a vega value or a rho value.

8. The computer-implemented method of claim 1, wherein the optimization objective comprises at least one of an expected profit objective, a return on investment objective, a risk to reward ratio objective, a probability of profit objective, or a derivative sensitivity analysis value minimization or maximization objective.

9. The computer-implemented method of claim 8, wherein the derivative sensitivity analysis value minimization or maximization objective comprises at least one of a delta value, a theta value, a gamma value, a vega value or a rho value.

10. The computer-implemented method of claim 1, wherein the plurality of optimization inputs further comprise an initial financial trade position, the method further comprising:
determining, by the platform, an optimized position for hedging purposes that extends the initial financial trade position by adding a hedging position to the initial financial trade position based on the plurality of optimization inputs; and
presenting, via the user interface, the optimized position to the user.

11. The computer-implemented method of claim 10, wherein the one or more modified optimization inputs comprise at least one of a modified consolidated performance prediction curve, a modified set of financial constraints, updated market information, or a modified optimization objective.

12. The computer-implemented method of claim 1, wherein the plurality of optimization inputs further comprise an initial financial trade position, the method further comprising:
determining, by the platform, an optimized position for position maintenance purposes that maintains the initial financial trade position by modifying the initial financial trade position based on the plurality of optimization inputs, and presenting, via the user interface, the optimized position to the user.

13. The computer-implemented method of claim 12, wherein the one or more modified optimization inputs comprise at least one of a modified consolidated performance prediction curve, a modified set of financial constraints, updated market information, or a modified optimization objective.

14. The computer-implemented method of claim 1, wherein the plurality of optimization inputs further comprise at least one of a probable slippage estimation rule, or a worst-case slippage estimation rule.

15. The computer-implemented method of claim 1, wherein determining the optimized financial trade position based on the plurality of optimization inputs comprises using a predicted orderbook to model slippage.

16. The computer-implemented method of claim 1, wherein the security comprises a security basket.

17. The computer-implemented method of claim 1, wherein determining the optimized financial trade position based on the plurality of optimization inputs comprises representing the consolidated performance prediction curve as a piecewise linear function.

18. The computer-implemented method of claim 1, wherein determining the optimized financial trade position based on the plurality of optimization inputs comprises applying a worst-case piecewise linear payoff curve to limit trade lifetime risk.

19. The computer-implemented method of claim 1, wherein determining the optimized financial trade position based on the plurality of optimization inputs comprises representing tied up capital as a maximum of a trade lifetime risk capital, an entry net cash requirement, and a required margin capital.

20. The computer-implemented method of claim 1, wherein determining the optimized financial trade position based on the plurality of optimization inputs comprises replacing a contract payoff curve with a prediction-weighted-average profit/loss value.

21. The computer-implemented method of claim 1, wherein determining the optimized financial trade position based on the plurality of optimization inputs comprises an algorithm using a linear programming method.

22. The computer-implemented method of claim 1, wherein determining the optimized financial trade position based on the plurality of optimization inputs comprises an algorithm using a mixed integer programming solver.

23. The computer-implemented method of claim 1, wherein presenting the optimized financial trade position to the user comprises displaying one or more output graphs indicating a probability an optimized trade's profit or loss will exceed a threshold value based on the consolidated performance prediction curve.

24. The computer-implemented method of claim 1, wherein the consolidated performance prediction curve is associated with at least one of a future target trade date or a trade horizon.

25. The computer-implemented method of claim 1, wherein the user-specified time comprises a future period of time.

26. The computer-implemented method of claim 1, wherein the plurality of optimization inputs further comprise one or more user-inputted trading constraints comprising at least one of a limit on a type of capital that may be allocated to the optimized financial trade position or a limit on a size of the optimized financial trade position based on contract quantity.

27. A computer-implemented method, comprising:
receiving a plurality of optimization inputs comprising a plurality of consolidated performance prediction curves each associated with a security, a set of financial constraints, market information, and an optimization objective;
determining, based on the plurality of optimization inputs, an optimized financial trade position comprising a plurality of prediction trades; and
presenting, via a user interface of a computer, the optimized financial trade position to a user.

28. A computer-implemented method, comprising:
receiving, from a user, a future outcome event relating to a security and a plurality of minimum and maximum performance values associated with one or more user confidence levels;
generating an outcome prediction curve based on the plurality of minimum and maximum performance values;
associating the outcome prediction curve with the future outcome event; and
presenting, by the platform via a user interface of a computer, the outcome prediction curve to the user.

29. The computer-implemented method of claim 28 further comprising:
determining, by the platform, an optimized financial trade position based on a plurality of optimization inputs comprising the outcome performance prediction curve, a set of financial constraints, market information, and an optimization objective; and
presenting, by the platform via the user interface, the optimized financial trade position to the user.

30. A computer-implemented method, comprising:
receiving, from a user, a plurality of outcome events relating to a security and a plurality of minimum and maximum performance values associated with one or more user confidence levels for each outcome event;
generating a plurality of outcome prediction curves each corresponding to one of the plurality of outcome events, based on the plurality of minimum and maximum performance values for the one of the plurality of outcome events;
associating each of the plurality of outcome prediction curves with a corresponding one of the plurality of outcome events;
receiving, by a platform executable by a processor, a prediction tree comprising a plurality of nodes each corresponding to one of the plurality of outcome events, one or more alternative outcome events, and one or more independent outcome events;
consolidating, by the platform, the plurality of nodes of the prediction tree into a consolidated performance prediction curve; and
presenting, by the platform via a user interface of a computer, the consolidated performance prediction curve to the user.

31. The computer-implemented method of claim 30, wherein at least one of the one of the plurality of outcome events, the one or more alternative future outcome events or the one or more independent future outcome events are associated with one or more of a probability weight, an impact weight or a confidence weight.

32. The computer-implemented method of claim 30 further comprising:
determining, by the platform, an optimized financial trade position based on a plurality of optimization inputs comprising the consolidated performance prediction curve, a set of financial constraints, market information, and an optimization objective; and
presenting, by the platform via the user interface, the optimized financial trade position to the user.

33. A computer-implemented method, comprising:
providing, by a user via a user interface of a computer, a plurality of optimization inputs relating to a security, the optimization inputs comprising a consolidated performance prediction curve representing the user's consolidated view of a probability associated with each of a plurality of different future performance levels associated with the security at a user-specified time; a set of financial constraints, market information, and an optimization objective; and
receiving, by the user via the user interface, an optimized financial trade position based on the plurality of optimization inputs.

34. A computer-implemented method, comprising:
providing, by a user via a user interface of a computer to a computer platform, a plurality of outcome events relating to a security and a plurality of minimum and maximum performance values associated with one or more user confidence levels for each outcome event;
receiving, by the user via the user interface from the computer platform, a plurality of outcome prediction curves each corresponding to one of the plurality of outcome events, based on the plurality of minimum and maximum performance values for the one of the plurality of outcome events, wherein each of the plurality of outcome prediction curves is associated with a corresponding one of the plurality of outcome events;
providing, by the user via the user interface, a prediction tree comprising a plurality of nodes each corresponding to one of the plurality of outcome events, one or more alternative outcome events, and one or more independent outcome events; and
receiving, by the user via the user interface from the computer platform, a consolidated performance prediction curve comprising a consolidation of the plurality of nodes of the prediction tree.
